(19) United States
(12) Patent Application Publication
(10) Pub. No.: US 2020/0380433 A1
(43) Pub. Date: Dec. 3, 2020

(54) SYSTEMS AND METHODS FOR DETECTING AND ALLOCATING LOGISTICAL EVENTS CORRESPONDING TO CONTROLLING HAZARDOUS CONDITIONS AND WORKFLOWS AT SITES

(71) Applicant: VITRALOGY IP, LLC, Bohemia, NY (US)

(72) Inventor: Philip Thomas D'Amelia, Nesconset, NY (US)

(21) Appl. No.: 16/934,739

(22) Filed: Jul. 21, 2020

Related U.S. Application Data
(63) Continuation-in-part of application No. 16/209,696, filed on Dec. 4, 2018.
(60) Provisional application No. 62/877,736, filed on Jul. 23, 2019.
(60) Provisional application No. 62/594,881, filed on Dec. 5, 2017.

(51) Int. Cl. G06Q 10/06; G06F 16/242; G06F 16/2457

(52) U.S. Cl. CPC G06Q 10/0633; G06Q 10/06315; G06F 16/24575; G06F 16/244; G06F 16/2428; G06Q 10/06312

(57) ABSTRACT

This disclosure relates to techniques for controlling hazardous conditions and workflows at various sites, such as residential or commercial buildings. A logistics platform can include functionality for monitoring the hazardous conditions, which can include hazardous biological or chemical conditions, associated with the sites. Dynamic models can be generated for controlling workflows related to managing the hazardous conditions. Inputs can be received at the logistics platform from monitoring equipment that includes sensors that enable real-time tracking of the hazardous conditions. Inputs can additionally, or alternatively, be received over a network from electronic devices. The execution of the workflows can be controlled using the dynamic models and the inputs received. The logistics platform can detect logistical events associated with the workflows, at least in part, using the dynamic models. A channel allocation component can group the logistical events into channels and enable the channels to be assigned to task execution individuals.

### CROSS-REFERENCE TO RELATED APPLICATIONS

This application claims priority to U.S. Provisional Patent Application No. 62/877,736 filed on Jul. 23, 2019. This application is also a continuation-in-part of U.S. patent application Ser. No. 16/209,696 filed on Dec. 4, 2018, which claims priority to U.S. Provisional Patent Application No. 62/594,881 filed on Dec. 5, 2017. Each of the aforementioned applications is herein incorporated by reference in its entirety.

### TECHNICAL FIELD

The present disclosure is directed to an automated platform for handling hazardous conditions (e.g., hazardous biological conditions and chemical conditions) and workflows at sites. In certain embodiments, the platform includes tools for generating dynamic models for use with automating logistics operations, integrating the dynamic models into software applications utilized by various stakeholders associated with managing or implementing the logistics operations, and tracking and managing the progress of the logistics operations using the integrated dynamic models. In certain embodiments, the platform detects various logistical events associated with the sites, and merges or groups the events into channels that can be allocated to task execution individuals who oversee and facilitate execution of the logistical events.

### BACKGROUND

Managing logistical operations often involves detailed coordination of operations involving numerous persons, facilities, and/or supplies. These operations are typically required to be scheduled and executed precisely within small time frames. Even the smallest of mishaps can cause an entire workflow to breakdown. In many cases, the breakdown of a workflow can result in loss of customers, fines to businesses, and/or harm to individuals.

Various industries and businesses are faced with obstacles associated with managing complex logistical operations. For example, in the transportation industry, logistics operations are typically aimed at ensuring coordinated movement of goods or persons from an origin to a destination. In the military services, logistics operations are utilized to maintain supply lines and to ensure that resources are transported to where they are needed by military personnel. Proper management of logistical operations also plays a large role in manufacturing industries, inventory control services, and various functions performed by businesses, organizations, and governments.

Property management is another area that is facing increasingly complex logistics operations. Property managers are typically responsible for managing sites (e.g., residential buildings, commercial buildings, industrial buildings, facilities, or other types of property locations) and monitoring various conditions at those sites. Monitoring and managing multiple sites can be labor-intensive and requires significant resources to be devoted to scheduling, managing, and following up with vendors to perform various tasks. Such activities are particularly challenging in view of complex regulatory climates that require the property managers to undertake various actions to ensure compliance with applicable regulations and laws (e.g., environmental regulations that may require compliance with applicable state, federal, and local environmental regulations and laws). In addition to understanding and keeping up with the current obligations that are imposed by these regulations, property managers are faced with the daunting task of coordinating and scheduling activities among multiple vendors and other parties to perform tasks in connection with compliance measures. Such activities are resource-intensive and prone to significant errors when performed manually or when relying mainly on persons to manage and execute the tasks. These errors can be particularly disruptive and costly as fines may be imposed, licenses can be revoked, and individuals can be harmed.

One important role that property managers hold involves ensuring compliance with regulations directed to preventing or curing hazardous conditions (e.g., biological/chemical hazards) at the various sites. For example, the New York City Department of Health and Mental Hygiene has recently enacted environmental regulations that pertain to treating water stored in water or cooling towers for legionella and other biological agents. In order to comply with these regulations, property managers are required to undertake different types of tasks (e.g., submitting water samples for laboratory testing, cleaning and treating water with biocides, cleaning water tower structures, draining and filling the tower structures, and performing maintenance on the tower structures and associated water systems). In addition to being complex, these tasks require coordination among many different parties (e.g., service providers for performing the tasks, individuals at the sites, and governmental compliance personnel). Moreover, many of these tasks are required to be completed within precise time frames. The regulations impose very specific time limits for performing such tasks, and failure to perform the tasks in the required time frames can result in heavy fines.

Property managers are also tasked with handling integrated facilities management (IFM) operations. These operations can include tasks associated with interior property services (e.g., building maintenance, plumbing services, electrical services, HVAC services, computer services, and/or cleaning services); exterior property services (e.g., construction projects, snow removal, and/or landscaping services); safety conditions (e.g., related to safety measures associated with protection against fires, earthquakes, tornados, or inclement weather); and other types of tasks. In certain cases, the property managers are also required to oversee compliance with property-related governmental regulations (e.g., housing regulations, zoning regulations, and/or regulations pertaining to landlords).

Each site has a unique set of logistical challenges and requirements. The logistical challenges of each site may vary based on the equipment that is available at the facility and the activities that are currently ongoing at the sites.

For example, certain sites may have multiple water towers that require monitoring and maintenance services, while other sites have one cooling tower or no cooling towers. Likewise, certain sites may routinely utilize snow removal services (e.g., in cold weather climates), while other sites routinely utilize landscaping services (e.g., in warmer climates). The logistical challenges of each site may also vary based on how tasks are allocated and carried out at the sites. For example, certain sites may outsource some or all of the tasks associated with cleaning water towers to third-party service providers (also referred to herein as “vendors”), while other sites utilize in-house personnel or employees to handle such tasks. Similarly, certain sites may choose to outsource some or all of the interior and exterior property services to third-party vendors or service providers, while other sites utilize in-house personnel or employees to handle such tasks.

Because the logistical challenges for each site can vary greatly, there is no centralized solution or single platform that can adequately assist the property managers with managing the tasks at various sites. A platform that is configured to provide assistance at one particular site is typically inadequate and unsatisfactory for providing assistance at a majority of other sites. Therefore, to accommodate various sites, a customized platform would have to be designed for each of the sites to account for the specific and varying needs of the sites. Because developing customized solutions for each site can be very expensive in terms of labor and costs, property managers have not done so and, instead, have largely chosen to handle property management tasks manually. As mentioned above, handling such tasks manually can result in significant errors and runs a high risk of incurring fines and providing inadequate service at the sites, which can be detrimental to the health of individuals at the sites.

As various issues arise at the sites, another challenge relates to ensuring that the issues are attended to in a timely manner. This complexity of attending to the issues can grow exponentially in scenarios involving large numbers of sites, each of which may require multiple issues to be handled on a daily basis. In these scenarios, it may be difficult to communicate with the stakeholders responsible for handling those issues in an efficient, effective, and non-redundant manner. The efforts to effectively communicate with such stakeholders can be further complicated if the stakeholders are responsible for managing unrelated issues at a multitude of sites.

In view of the foregoing, there is a need for a platform that is able to generate customized models that can be tailored to complex logistical workflows at a plurality of sites that have varying needs, and which can be integrated into software solutions that assist property managers or other individuals and organizations with handling ever-changing local conditions at the sites and automating management of the logistical workflows at the sites. There is also a need for a platform that enables effective communication with stakeholders who are responsible for resolving issues at the sites in a timely manner.

### BRIEF DESCRIPTION OF DRAWINGS

The inventive principles are illustrated in the figures of the accompanying drawings, which are meant to be exemplary and not limiting, and in which:

FIG. 1A is a block diagram of a system according to certain embodiments;

FIG. 1B is a block diagram of an exemplary logistics platform according to certain embodiments;

FIG. 2 is an exemplary node diagram for a dynamic model that is utilized to automate workflows according to certain embodiments;

FIG. 3 is an exemplary interface for defining and adding nodes to be inserted into a node diagram for a dynamic model according to certain embodiments;

FIG. 4 is an exemplary method according to certain embodiments;

FIG. 5 is another exemplary method according to certain embodiments;

FIG. 6 is an exemplary interface that may be displayed by a channel allocation component according to certain embodiments;

FIG. 7 is another exemplary interface that may be displayed by a channel allocation component according to certain embodiments;

FIG. 8 is another exemplary interface that may be displayed by a channel allocation component according to certain embodiments;

FIG. 9 is another exemplary interface that may be displayed by a channel allocation component according to certain embodiments;

FIG. 10 is another exemplary interface that may be displayed by a channel allocation component according to certain embodiments;

FIG. 11 is another exemplary interface that may be displayed by a channel allocation component according to certain embodiments; and

FIG. 12 is another exemplary method according to certain embodiments.

### DESCRIPTION OF EXEMPLARY EMBODIMENTS

This disclosure relates to an electronic logistics platform that includes tools for generating dynamic models that are utilized for automating logistics planning and management operations at various sites. The dynamic models can be utilized to automate logistics planning and management operations for hazardous biological conditions (e.g., hazardous conditions related to legionella) and chemical conditions at various sites. The dynamic models additionally, or alternatively, can be utilized to automate logistics planning and management operations for IFM operations and other workflows at various sites.

In certain embodiments, the dynamic models and/or other features of the platform can be configured to detect or generate logistical events corresponding to tasks, deadlines, issues, and/or other events that arise at the sites. A channel allocation component can group the logistical events into separate channels based on certain relationships or criteria. Each channel may represent, or correspond to, a selectable electronic option that enables details associated with one or more logistical events (e.g., such as descriptions of the logistical events, deadlines associated with the logistical events, sites associated with the logistical events, and/or individuals associated with executing the logistical events) to be viewed and various actions to be executed and/or scheduled in connection with the one or more logistical events. The channels can then be allocated to task individuals who oversee and manage execution of the logistical events. This enables the logistical events to be timely scheduled and completed within acceptable timeframes. It also helps to ensure that communications with various stakeholders (e.g., vendors, property managers, etc.) are conducted in an efficient and non-redundant manner. Further details of the channel allocation component are described further below.

The dynamic models generated by the platform are customizable at granular levels to account for the specific logistical challenges at each of the sites. The dynamic models may be integrated into software applications that are accessible by various stakeholders (e.g., property managers, vendors, and site personnel) tasked with managing or implementing operations at the sites. The stakeholders can utilize the software applications to provide inputs and feedback directed to carrying out operations and for managing the tasks. The platform also can be configured to receive inputs comprising real-time data from equipment and sensors that monitor conditions at the sites. The software applications can utilize the dynamic models to automate process flows at the sites, and to automatically select and present interfaces to the stakeholders based on the received inputs and feedback received from the stakeholders and/or monitoring equipment.

A dynamic model for capturing the logistical operations of a site is comprised of a plurality of nodes that are linked to one another with connectors to control how the workflow will proceed based on received inputs. The nodes are typically configured to represent activities associated with a workflow and can be customized according to various criteria discussed herein, and the connectors indicate how the workflow transitions among the nodes and may indicate time frames for completing activities associated with the nodes. The platform includes a modeling tool that enables users to quickly and easily generate customized models for the logistics planning and management operations at each of the sites. The modeling tool presents one or more interfaces that enable a user to specify various criteria for the nodes and their associated connectors at very granular levels. In certain embodiments, the interfaces enable the user to define the type of node that is being included in the diagram; to specify and associate a plurality of sub-tasks with the node; to designate individuals (e.g., third-party vendors or in-house personnel) who are responsible for executing or overseeing tasks associated with the node; to link the nodes to other diagrams (e.g., in order to initiate execution of parallel workflow threads); to link the nodes to inputs provided by input forms and/or other inputs received from site equipment (e.g., real-time inputs generated by sensors and/or monitoring equipment); and to specify conclusion parameters that are utilized to control how the workflow will proceed to other nodes included in the diagram based on the received inputs and/or detected conditions at the site.

The modeling tool can be configured to digitally capture and/or represent any type of workflow. Each workflow may be associated with one or more activities that are be undertaken or executed at a site, and some or all of the activities may be associated with deadlines indicating when the activities are to be executed. For example, with respect to managing biological conditions at a site, a high-level or broad-level workflow at a site may relate to monitoring biological conditions (e.g., legionella conditions) at a site in accordance with deadlines specified by compliance regulations. More specific workflows may correspond to each activity associated with monitoring the biological conditions and/or remediating detected biological conditions (e.g., such as workflows that facilitate testing of water, cleaning of water towers, etc.). Likewise, with integrated facilities management operations, workflows relate to activities associated with securing a site, cleaning a site, removing snow or floodwater at a site, performing computer system maintenance at site, etc. Any of the workflows (and/or the activities and deadlines associated with the workflows) can be digitally captured and/or represented using the modeling tool.

In certain embodiments, the modeling tool is configured to generate a node-based diagram for a site that captures or represents the logistical workflow at the site. The modeling tool is configured to present graphical user interfaces (GUIs) to create and update the node-based diagrams. The interfaces presented include functions for creating new diagrams, inserting a variety of different nodes into the diagrams, dynamically linking the nodes to customized interfaces incorporated into software applications presented to stakeholders, dynamically linking the nodes to real-time data captured by equipment at the sites (e.g., monitoring equipment and sensors), and dynamically linking the nodes to one or more additional diagrams to initiate concurrent workflows that execute in parallel to one another.

The interfaces displayed by the modeling tool provide an interactive, node-based diagram that visually represents the dynamic models using a plurality of nodes and their associated connections. Each node of the diagram is associated with criteria that can be customized by an individual who is utilizing the modeling tool to create a diagram. The criteria associated with the node can link the node to inputs received from individuals associated with implementing the workflow and/or inputs received from sensory equipment located at the sites (e.g., sensors for monitoring conditions at the sites). The criteria associated with the node can also define conclusion parameters that control how the process flow will progress to other nodes included in the dynamic model that was generated. The conclusion parameters may be utilized to control the procession of the process flow to other nodes based on the inputs received from the individuals and/or the inputs received from sensory equipment.

The dynamic models generated by the logistics platform utilize a ruleset to detect certain triggering events that will automatically initiate one or more actions to be taken by the platform. The ruleset is defined, at least in part, by the criteria specified for the nodes. In certain embodiments, a user can add rules to the ruleset when the user is defining the nodes that are being added to the diagram being created with the modeling tool. For example, rules can be added to automatically generate alerts or notifications (e.g., push alerts, alerts displayed on interfaces, and/or inbox messages associated with user accounts) in response to detecting triggering events that indicate actions should be taken at the sites. This can include the sending of alerts and notifications associated with corrective measures at the sites in response to detecting certain conditions at the sites (e.g., in response to detecting unacceptable biological or chemical conditions at the sites). This may involve initiating automatic procedures for scheduling vendors to perform certain tasks and/or activating remediation equipment at those sites.

The dynamic models created and utilized by the platform can be easily updated or modified as the logistical needs of a site change over time. The underlying data associated with the diagrams are stored in a database provided by the platform. A user seeking to update a previously created dynamic model can load a stored model that will be presented on a GUI to the user via the modeling tool feature. The user can then provide inputs via the GUI to easily update the dynamic model. For example, the user can add, edit, or delete nodes; adjust the workflow transitions between the nodes; and/or adjust criteria associated with nodes (e.g., edit node types and/or conclusion parameters). Once a model has been updated, the updated model is automatically integrated into the software solutions utilized by the stakeholders to manage workflows at the site. In certain embodiments, the dynamic model is accessed by the stakeholders over a network at a centralized location and the updating is performed automatically given the centralized configuration of the system.

The logistics platform can generally be configured to provide assistance with automating the planning, management, and execution of logistics operations in any type of business, organization, or industry. The logistics platform is particularly useful for businesses, organizations, or industries involving complex logistics operations that require customized solutions at very granular levels. In certain embodiments, the logistics platform is configured to provide assistance with logistics operations with one or more of the following: property management services and operations; transportation services and operations; military services and operations; manufacturing services and operations; and inventory management services and operations. The logistics platform can also be utilized in other types of business-related or government-related services and operations.

In certain embodiments, the logistics platform is configured to provide assistance with automating logistical operations associated with property management operations. For example, in certain embodiments, the logistics platform is integrated with, or otherwise utilized by, the platform described in U.S. patent application Ser. No. 15/715,698, the content of which is herein incorporated by reference in its entirety.

In these embodiments, the logistics platform can be configured to ensure compliance with regulatory schemes directed to managing biological and/or chemical conditions at different properties or sites. For example, the logistics platform can be configured to create dynamic models that control logistics operations associated with treating water stored in water towers or cooling towers for legionella and other biological agents. The dynamic models can utilize data received by the platform from various stakeholders and/or monitoring equipment to detect triggering events and to trigger actions to be undertaken. For example, the received data can trigger actions such as taking water samples for laboratory testing, cleaning and treating water with biocides, cleaning water tower structures, draining and filling the tower structures, and performing maintenance on the tower structures and associated water systems. The dynamic models automate the coordination of actions among various parties (e.g., property managers, third-party service providers or vendors, and governmental compliance personnel) to ensure safe conditions at the sites and to take any necessary corrective or preventive measures.

In certain embodiments, the dynamic models generated by the logistics platform can also be configured to provide assistance with property management operations that involve integrated facilities management (IFM) tasks. The dynamic models can be configured to control process flows of operations that include tasks associated with interior property services (e.g., building maintenance, plumbing services, electrical services, HVAC services, computer services, and/or cleaning services), exterior property services (e.g., construction projects, snow removal, and/or landscaping services), safety conditions (e.g., related to safety measures associated with protection against fires, earthquakes, tornados, or inclement weather), property-related governmental regulations (e.g., housing regulations, zoning regulations, and/or regulations pertaining to landlords), and/or other types of tasks. Once again, the dynamic models can utilize data received by the platform from various stakeholders and/or monitoring equipment to detect triggering events (e.g., breakdown of equipment) and to trigger any necessary corrective actions or preventive measures (e.g., scheduling vendors or individuals to attend to tasks).

The platform and related features described in this disclosure provide numerous advantages over prior art techniques for managing logistics operations. With prior art techniques, the logistics of managing operations at a plurality of properties has largely been handled manually because the complex logistical challenges for each site can vary greatly. In contrast, the logistics platform described herein provides a solution that permits property managers to generate customized, dynamic models that are tailored to logistical challenges at each of the sites and which allow for automation of logistical operations at the sites. The platform reduces the time and expense associated with handling logistics at each of the sites, and provides a single, centralized platform that can be utilized to handle operations at a plurality of sites. By integrating the dynamic models into software solutions that are accessible to the various stakeholders (e.g., property managers, in-house employees, third-party service providers, and testing laboratories), all relevant stakeholders are immediately able to take necessary actions and/or corrective measures. Further, by integrating the dynamic models into software solutions that communicate with equipment (e.g., monitoring equipment and remediation equipment) at the sites, unfavorable conditions can be detected in real time, and devices at the sites can be remotely activated to cure, mitigate, or prevent occurrences of the unfavorable conditions. These advantages are particularly important in scenarios where failure to take quick and immediate actions can result in harm or death to individuals.

The inventive principles set forth in the disclosure provide the above-described advantages by applying technical improvements that are rooted in computer and automation technologies to overcome existing problems associated with ensuring compliance with regulations or other obligations, specifically problems dealing with the monitoring of environmental and facilities management conditions and automating logistics operations at sites. These technological improvements provide tools for generating dynamic models and integrating the models into software solutions in a user-friendly manner that does not require individuals to possess technical knowledge, and which account for the dynamic nature of logistics operations. The models generated using the platform can be easily linked with other models to initiate separate threads for workflows or sub-routines to be carried out in parallel. Further, the dynamic models permit automated control of logistics operations at various sites based on inputs received from integrated equipment (e.g., sensors, devices, and/or equipment at the sites) and supplied by the stakeholders. These inputs allow for real-time monitoring of conditions at the sites and permit automated remedial actions to be immediately undertaken (e.g., by activating remediation equipment at the sites and/or notifying applicable stakeholders to take actions). Thus, the dynamic models created and utilized by the centralized platform enable simultaneous monitoring of environmental conditions, facilities management conditions, and other conditions at a plurality of sites. This technology-based solution marks a technical improvement over existing solutions for managing logistics operations and ensuring compliance with environmental regulations and facilities management obligations by improving the manner in which unfavorable conditions are detected and managed at the sites.

The embodiments described in this disclosure can be combined in various ways. Any aspect or feature that is described for one embodiment can be incorporated into any other embodiment mentioned in this disclosure. Moreover, any of the embodiments described herein may be hardware-based, software-based and, preferably, comprise a mixture of both hardware and software elements. Thus, while the description herein may describe certain embodiments, features, or components as being implemented in software or hardware, it should be recognized that any embodiment, feature, or component that is described in this disclosure may be implemented in hardware and/or software. In certain embodiments, particular aspects are implemented in software which includes, but is not limited to, firmware, resident software, microcode, etc.

Embodiments may include a computer program product accessible from a computer-usable or computer-readable medium providing program code for use by, or in connection with, a computer or any instruction execution system. A computer-usable or computer-readable medium may include any apparatus that stores, communicates, propagates, or transports the program for use by, or in connection with, the instruction execution system, apparatus, or device. The medium can be a magnetic, optical, electronic, electromagnetic, infrared, or semiconductor system (or apparatus or device), or a propagation medium. The medium may include a computer-readable storage medium, such as a semiconductor or solid state memory, magnetic tape, a removable computer diskette, a random access memory (RAM), a read-only memory (ROM), a rigid magnetic disk, an optical disk, etc.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code to reduce the number of times code is retrieved from bulk storage during execution. Input/output (I/O) devices (including, but not limited to, keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The discussion that follows below is directed to exemplary embodiments in which the platform is configured to assist property managers with handling logistics operations associated with managing environmental conditions and IFM operations at various sites. However, it should be recognized that the inventive principles discussed below, and throughout this disclosure, can be adapted for use with other types of industries, organizations, businesses, or services (e.g., those associated with transportation, military, manufacturing, inventory control, and/or other services).

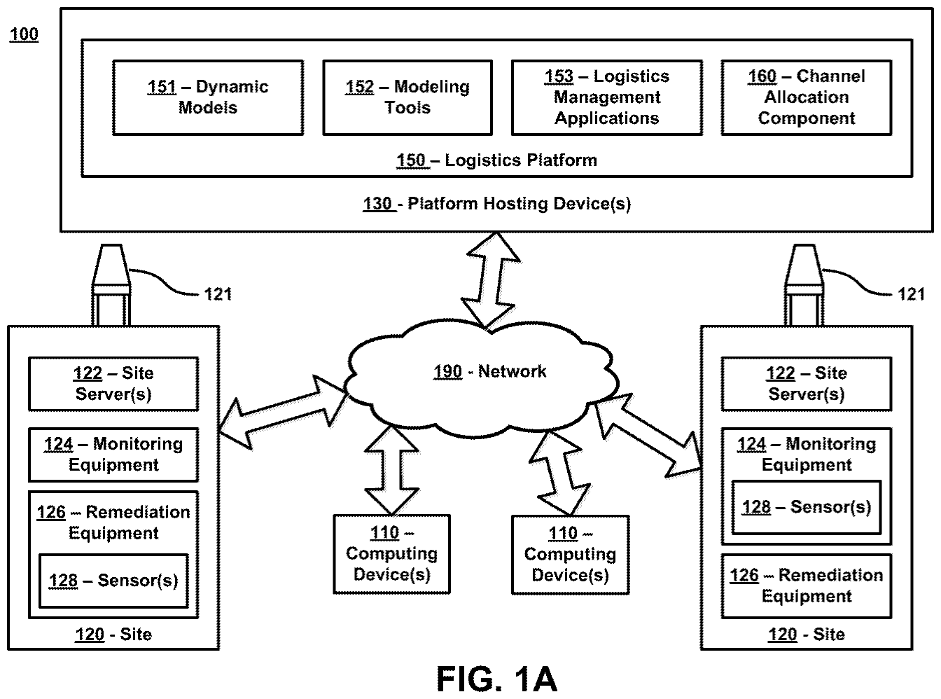

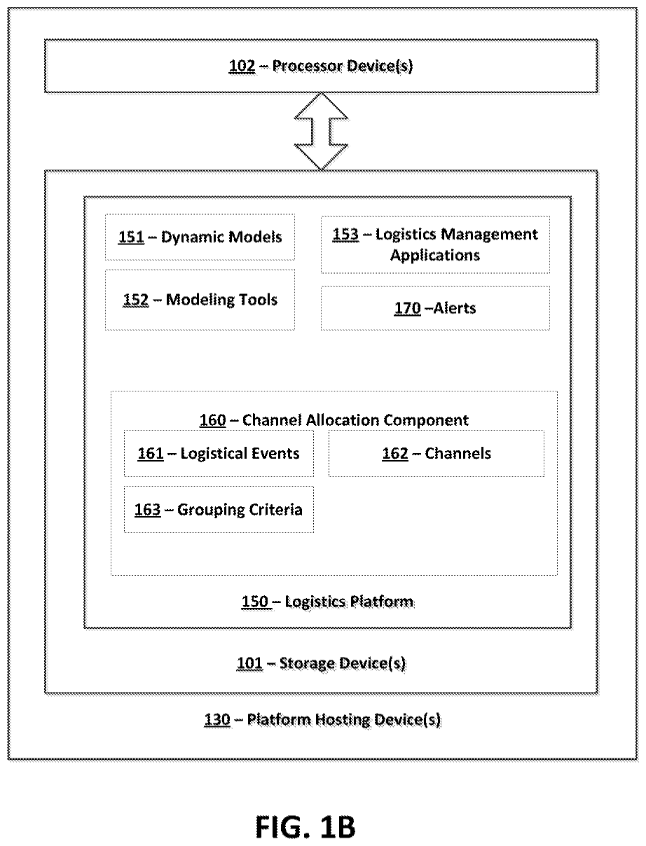

FIGS. 1A-1B disclose exemplary embodiments for implementing techniques described herein. FIG. 1A is a block diagram of a system 100 that includes an electronic logistics platform 150 for controlling and/or managing operations at one or more sites in accordance with certain embodiments. FIG. 1B is a block diagram illustrating further details of an electronic logistics platform 150 according to certain embodiments.

As shown in FIG. 1, a platform hosting device 130 includes an electronic logistics platform 150 that provides a comprehensive set of modeling tools 152, which may include various electronic and/or software-based functions for designing customized dynamic models 151 that can be integrated into logistics management applications 153 to automate workflow control and management operations in a manner that accounts for dynamically changing conditions at a plurality of sites 120. In certain embodiments, the dynamic models 151 are able to be customized for each site to enable automated control of any and all operations associated with preventing, mitigating, and/or remediating occurrences of unfavorable conditions (e.g., hazardous biological/chemical conditions or facilities management conditions) at the sites 120. In this exemplary system, one or more of the sites 120 include cooling towers 121 and/or water towers 121. The platform hosting device 130 is in communication with the sites 120 over a network 190. The platform hosting device 130 is also in communication with one or more computing devices 110, which are operated by various stakeholders such as site/facility/building managers, service providers/vendors, property owners, platform administrators, and other individuals.

As shown in FIG. 1B, the electronic logistics platform 150 can be stored on one or more storage devices 101 that are in communication with one or more processors 102. The one or more storage devices 101 can include: i) non-volatile memory, such as, for example, read-only memory (ROM) or programmable read-only memory (PROM); and/or (ii) volatile memory, such as, for example, random access memory (RAM), dynamic RAM (DRAM), static RAM (SRAM), etc. In these or other embodiments, storage devices 101 can comprise (i) non-transitory memory and/or (ii) transitory memory. The one or more processors 102 can include one or more central processing units (CPUs), graphical processing units (GPUs), controllers, microprocessors, digital signal processors, and/or computational circuits. The one or more storage devices 101 can store data and instructions associated with implementing dynamic models 151, modeling tools 152, logistics management applications 152, and a channel allocation component 160. The one or more processors 102 can be configured to execute instructions associated with these components. Each of these components is described in further detail below.

As explained in further detail below, the dynamic models 151 and/or other features of the platform 150 can be configured to detect or generate logistical events 161 at each of the sties 120 (e.g., events that associated with preventing, mitigating, and/or remediating occurrences of unfavorable hazardous biological/chemical conditions and/or unfavorable facilities management conditions) at the sites 120. In some embodiments, the logistical events 161 may be detected and/or generated using the dynamic models 151 and/or in response to monitoring information (e.g., data that is received at the platform 150 from monitoring equipment 124 and/or data that is received from electronic computing devices 110 that are operated by vendors). The channel allocation component 160 can group the logistical events 161 into channels 162 based on certain grouping criteria 163. The channels 162 can then be allocated to individuals who assist with ensuring the logistical events 161 associated with the channels 162 are scheduled and completed in a timely manner.

In certain embodiments, the channels 162 may include, or correspond to, selectable electronic options that are displayed on a graphical user interface. In response to selecting a channel 162, the interface may display details pertaining to the logistical events associated with the channel 162. For example, the interface may display information that describes the logistical events (e.g., indicating whether the logistic events pertain to managing biological conditions such as tower cleaning or water testing, or facilities managing conditions such as snow removal or HVAC maintenance), identifies deadlines associated with the logistical events, identifies sites associated with the logistical events, and/or identifies individuals (e.g., vendors, property managers, and/or other stakeholders) associated with executing the logistical events) to be viewed. The interface associated with the channel 162 may also include selectable options that enable various actions to be executed and/or scheduled in connection with the one or more logistical events (e.g., such as assigning the channels to task execution individuals, sending alerts to stakeholders, activating remediation equipment, and/or other actions).

In certain embodiments, the electronic logistics platform 150 represents a network-based, web-based, and/or cloud-based platform that is accessed over the network 190 by the computing devices 110 operated by the stakeholders. The network 190 can be any type of network, such as one that includes the Internet, a local area network, a wide area network, a personal area network, an intranet, a cellular network, and/or other network. The platform 150 is hosted on one or more servers, or other devices, which are configured to communicate with the computing devices 110 and the sites 120 (e.g., to communicate with servers 122, monitoring equipment 124, remediation equipment 126, sensors 128, and/or other devices located at the sites 120). The computing devices 110, site servers 122, and platform hosting devices 130 may represent desktop computers, laptop computers, mobile devices (e.g., cell phones, smart phones, or personal digital assistants), tablet devices, wearable devices (e.g., smart watches, smart glasses, etc.) and/or other types of computing devices. The computing devices 110, sites 120, servers 122, monitoring equipment 124, remediation equipment 126, sensors 128, and platform hosting devices 130 can be configured to communicate via wired or wireless links, or a combination of the two. These components can communicate directly with one another and/or via the network 190. Each may be equipped with one or more computer storage devices (e.g., including, but not limited to, any of the storage devices 101 mentioned herein) and one or more processing devices (e.g., including, but not limited to, any of the processing devices 102 mentioned herein) that are capable of executing computer program instructions. The computer storage devices are preferably physical, non-transitory mediums.

In certain embodiments, the computer storage devices 101 of the platform hosting device 130 are configured to store data, applications, scripts, databases, and/or other information for implementing any and all functions described herein, including functions for generating dynamic models 151 (e.g., using the modeling tools 152), integrating the dynamic models 151 into logistics management applications 153, utilizing the dynamic models 151 and logistics management applications 153 to track and manage logistics operations at the sites 120, grouping and/or merging logistical events 161 in channels 162, allocating the channels 162 to one or more individuals, and other related features described in this disclosure. The computing devices 110 operated by the property managers, service providers, and other users can include software applications that communicate with the platform 150 to access the dynamic models 151, modeling tools 152, logistics management applications 153, channel allocation component 160, data, applications, scripts, databases, interfaces, and/or other information on the platform hosting device 130. The software applications can also enable the computing devices 110 to access the sites 120 (including all of its components) via the platform 150 and/or directly in order to remotely access and control the monitoring equipment 124 and remediation equipment 126. In certain embodiments, the platform 150 is alternatively, or additionally, implemented as a local application that is installed on the computing devices 110 operated by the users or site servers 122.

Each instance in which a property manager, individual, or organization desires to automate operations at a site 120, an authorized person, member, or user can access the modeling tools 152 on the logistics platform 150 to generate a new dynamic model 151 for monitoring and controlling the workflow at the site 120. For example, an option can be selected to create a new model 151 for automating logistics associated with monitoring and controlling the workflows at the site 120 for environmental conditions and/or IFM activities. Once the model 151 has been generated, it can be integrated into a logistics management application 153 that is accessible and utilized by different stakeholders utilizing the computing devices 110. Inputs received from stakeholders utilizing the computing devices 110 and/or equipment (e.g., monitoring equipment 124 and/or remediation equipment 126) is received over the network 190 by the platform 150, and the logistics management applications 153 utilize the integrated dynamic models 151 to make appropriate decisions regarding the workflows at the sites 120 and to take appropriate actions. The inputs are utilized by the models 151 to dynamically monitor, control, and manage operations at the sites 120.

The modeling tools 152 may be utilized by property managers, platform administrators (e.g., associated with a third-party service that provides the logistics platform 150 as a service to property managers and other individuals), or other users. In certain embodiments, the modeling tools 152 present the users with one or more graphical user interfaces (GUIs) that permit the users to create a node diagram that represents or models the workflow for a site 120. The users may utilize the one or more GUIs to insert nodes into the diagram and link the nodes to one another. The one or more GUIs may further permit the users to specify node criteria for each node. As discussed in further detail below, the node criteria can specify, inter alia: a node type that identifies the type of node being added (e.g., whether the node being added is being utilized to represent a specific workflow job or task, involves testing tasks to be conducted, and/or links to another model or diagram that initiates execution of a concurrent thread); inputs that are required for the node (e.g., inputs from service providers or equipment); conclusion parameters that specify where the process flow will transition based on the received inputs (e.g., which identify a node where the process flow will transition based on the inputs); event triggers that will cause certain actions to be undertaken (e.g., sending alerts/notifications or initiating corrective measures or preventative measures to be taken); vendors, service providers, in-house personnel, or other individuals who are to perform or oversee tasks associated with the node; and other criteria.

In certain embodiments, multiple dynamic models 151 may be utilized to automate logistics operations at a single site 120. For example, a user may utilize the modeling tools 152 to generate a first dynamic model 151 for controlling the workflow associated with managing environmental conditions pertaining to legionella testing; a second dynamic model 151 for controlling conditions pertaining to chemical testing (e.g., conditions associated with controlling asbestos, lead, or radon levels); a third dynamic model 151 for controlling conditions pertaining to other types of biological testing (e.g., conditions associated with controlling mold, insects, bacteria, or rodents); and a fourth dynamic model 151 for controlling IFM operations (e.g., for controlling interior or exterior IFM operations). Along similar lines, each of the dynamic models 151 mentioned above can be divided into a plurality of models 151 which are linked to one another, each of which is associated with controlling a subset of tasks associated with the model 151. For example, the dynamic model 151 for controlling the workflow of environmental conditions pertaining to legionella testing can be divided into several sub-models that control workflows for various tasks (e.g., tasks associated with treating and cleaning water, cleaning water tower structures, applying pesticides or disinfectants, supplying laboratory results, etc.) and each of the sub-models can be linked together.

In certain embodiments, a hierarchy of separate models 151 can be generated using the modeling tools 152 and the models can be linked together in a parent/child arrangement to control and monitor logistical operations. For example, a master model can be created for controlling and managing legionella conditions (or other hazardous conditions) at a site 120. The master model can be linked to one or more sub-models for controlling and managing a subset of tasks associated with managing the legionella conditions. For example, as mentioned above, the sub-models may be used to control and manage workflows for sub-tasks associated with treating and cleaning water, testing water conditions, cleaning water tower structures, applying pesticides or disinfectants, supplying laboratory results, etc. The master model can include nodes that initiate execution of the workflows associated with the sub-models in response to detecting certain conditions. For example, in response to detecting unsatisfactory legionella conditions at a node in the master model, the workflow may transition to a node that initiates execution of a sub-model that controls the workflow for mitigating or correcting the hazardous legionella conditions at the site 120. The hierarchy of linked models 151 can include any number of levels and can be customized according to the needs of the site 120. The modeling tools 152 can be utilized to specify whether or not sub-models are to be executed in parallel with the workflows of parent models, or whether the workflow of the parent models should be halted until execution of the sub-model has been completed.

The logistics management applications 153 utilize the dynamic models 151 to control logistics operations at the sites 120. The computing devices 110 permit stakeholders to access the logistics management applications 153 over the network 190. While the logistics management applications 153 are shown as being stored on the platform hosting device 130, the logistics management applications 153 can alternatively, or additionally, be stored in whole or in part on the computing devices 110. For example, the computing devices 110 may include a front-end application that communicates with the logistics management applications 153 on the platform hosting device 130, and/or the entirety of the logistics management applications 153 may be stored on the computing devices 110. The logistics management applications 153 provide interfaces to the stakeholders, which enable the stakeholders to provide inputs and feedback for executing or managing tasks defined by the dynamic models 151, to view statuses of workflows, to communicate with other stakeholders, to communicate with and control equipment at the sites 120 (e.g., monitoring equipment 124 and/or remediation equipment 126), to allocate tasks associated with the workflows to different stakeholders (e.g., in-house personnel and/or vendors), to receive alerts and notifications associated with executing and managing workflows, and to perform any other related functions discussed in this disclosure.

The logistics platform 150 can be configured to provide different types of permissions and interfaces to different stakeholders. For example, the logistics management applications 153 utilized by property managers and platform administrators may allow these stakeholders to perform a broad range of functions, e.g., such as generating and updating dynamic models 151, accessing the modeling tools 152, updating models 151 and workflows, controlling equipment at the sites 120, assigning channels 162 associated with sets of logistical events 161 to individuals, assigning vendors, laboratories or service providers to perform various tasks, and communicating with any associated stakeholders. The logistics management applications 153 utilized by vendors or service providers may allow these stakeholders to perform a more limited subset of tasks, e.g., such as providing inputs in connection with tasks assigned to specific vendors or service providers, uploading laboratory results, and accessing equipment that permits monitoring and/or remediation of site conditions that are associated with tasks assigned to the vendors or service providers. The property managers and platform administrators can specify which functions are available to the vendors or service providers. The logistics management applications 153 can be configured to provide appropriate interfaces to the stakeholders based on the permissions and functions available to the stakeholders.

In certain embodiments, the property or facility managers access the platform 150 to receive alerts 170 pertaining to logistical events 161 at one or more sites 120. For example, the alerts 170 may provide data or information associated with scheduling tasks (e.g., for complying with environmental regulations or facilities management obligations), checking statuses of upcoming or scheduled tasks, curing unfavorable conditions, and for other reasons. In certain embodiments, the scheduling of tasks is based on obligations imposed by regulatory compliance measures (e.g., which require property managers to periodically check certain environmental conditions at sites) and/or facilities management obligations. The dynamic models 151 and/or logistics management applications 153 can identify any relevant logistical events 161 associated with deadlines, tasks, or actions that should be taken in connection with fulfilling the obligations. The dynamic models 151 include criteria that specifies when stakeholders are to be notified or scheduled to perform tasks (e.g., tower cleaning, water treatment, and laboratory testing). The identification of logistical events 161 and/or scheduling of tasks can also be initiated by the detection of unfavorable or potentially unfavorable conditions at the sites 120. The detection of such conditions can be performed by in-person inspections performed by service providers and/or automatically by monitoring equipment 124 located at the sites (e.g., which include sensor devices configured to detect biological or chemical substances in the water or air supply at the sites).

The logistics platform 150 can automatically transmit notifications or alerts 170 to computing devices 110 (e.g., via the logistics management applications 153) operated by property managers, vendors, and/or other users at any appropriate time to notify the users of any events requiring their attention. In certain embodiments, the logistics management applications 153 are configured to automatically detect when environmental tasks should be performed or scheduled, when property managers or other stakeholders are delinquent on their obligations to perform environmental tasks, and/or when unfavorable conditions are present at sites. The platform 150 transmits notifications or alerts 170 to the users in the event that any such events are detected. The notifications or alerts 170 can be transmitted automatically without human intervention and/or in response to selections made by task execution individuals or other persons.

Each dynamic model 151 stores or includes a set of rules and event triggers that can immediately activate the sending of notifications or alerts 170, initiate a series of corrective measures, and/or perform other related functions. For example, in the event that the platform 150 receives an indication that unsatisfactory laboratory results have been obtained in connection with legionella testing (or other biological/chemical testing) at a site 120, the platform 150 can retrieve the dynamic model 151 associated with the site 120 to initiate a series of corrective measures (e.g., setting deadlines to correct measures, scheduling appropriate vendors for treating water, and scheduling a laboratory to analyze the treated water). Likewise, in response to detecting a broken HVAC system, the platform 150 can retrieve the dynamic model 151 associated with controlling IFM operations at the site 120 and initiate a series of corrective measures, such as notifying tenants/occupants of conditions, scheduling HVAC repair services, and reserving alternative space in the building for the tenants/occupants while repairs are ongoing. Any corrective measures taken by the platform 150 can be performed automatically by the platform 150 and/or with the assistance of an individual (e.g., property manager). The platform 150 can utilize the rules and triggers to perform similar actions in other scenarios involving other types of events.

The logistics management applications 153 can utilize the dynamic models 151 to prompt property managers to select or assign one or more vendors or service providers for completing the tasks. Generally speaking, the service providers listed on and made available via the platform can perform any task desired by the property managers including, but not limited to, tasks associated with executing and/or managing logistical events 161 detected or generated by the platform 150. For example, in the context of ensuring compliance with environmental regulations pertaining to water towers or cooling towers 121, the vendors can be called on to perform tasks for logistical events 161 related to treating and cleaning water, cleaning water tower structures, applying pesticides or disinfectants, supplying laboratory results (e.g., which provide an analysis of biological or chemical parameters present in the water), draining and filling the tower structures, and performing maintenance on the tower structures or water systems. The service providers scheduled through the platform 150 can perform tasks for logistical events 161 related to ensuring compliance with other types of environmental regulations (e.g., relating to asbestos, mold, etc.). The service providers scheduled through the platform 150 also can perform tasks for logistical events 161 related to facility management operations, such as tasks associated with building maintenance, cleaning services, construction services, computing services, snow removal services, security services, landscaping services, etc.

The platform 150 can be configured for use with facilities management software applications and systems that can provide assistance with maintenance and other site services; computer-aided facility management (CAFM) software and systems that can provide various forms of information technology pertaining to the sites; building automation systems (BAS) software that automates various aspects of a building (e.g., a building's heating, ventilation and air conditioning, lighting, and other systems); and/or any other type of system or software application that provides assistance with managing a site 120. The platform 150 can be directly integrated and packaged with such systems or software applications, or can communicate with such systems and software applications (e.g., via an application programming interface (API)).

As mentioned above, in certain embodiments, the platform 150 is configured to communicate with monitoring equipment 124 and remediation equipment 126 located at the sites 120. The dynamic models 151 can specify how data generated by such equipment is utilized to implement workflows at the sites 120 and/or when such equipment is to be activated or utilized to implement the workflows. For example, when creating or updating a dynamic model 151, a user may specify that a node included in the diagram for the model is to utilize data generated by monitoring equipment 124 to determine how the workflow is to proceed. Likewise, the user may also specify that a node is to activate remediation equipment 126 in response to detecting unfavorable conditions (e.g., hazardous biological or chemical conditions) at a site 120.

Generally speaking, the monitoring equipment 124 is utilized to determine whether unfavorable or potentially unfavorable conditions exist at the sites 120 and/or to determine whether service providers should be scheduled to perform tasks at the sites 120. The monitoring equipment 124 can be configured to detect the presence of hazardous or unfavorable conditions at the sites utilizing sensors 128, analysis hardware or software, and/or associated devices and circuitry. For example, the monitoring equipment 124 at a site 120 may include devices that include sensors 128 and/or analysis software for detecting the presence or potential presence of biological or chemical hazards, acidity conditions, weather conditions, and/or equipment functionality (e.g., HVAC, computing, electrical, or plumbing equipment functionality). Analog inputs received via the sensors can be converted to digital signals and evaluated by the analysis software to detect the presence of such hazards or unfavorable conditions. In response to detecting an unfavorable or potentially unfavorable condition at a site 120, the monitoring equipment 124 can transmit a signal (using wired or wireless communication techniques) over the network 190 to the platform 150 and site server 122. The alert signal can then be relayed to one or more computing devices 110 to notify the associated property manager (or other individuals) of the detected condition. The alert signal can also be utilized by the dynamic models 151 to automatically identify corresponding logistical events 161 and automatically initiate certain corrective actions. In this manner, the platform 150 provides real-time monitoring of environmental and facility conditions at the sites 120 and allows remediation actions to be taken to cure the conditions. In certain embodiments, in response to the monitoring equipment 124 detecting an unfavorable condition at a site, the ruleset associated with the dynamic model 151 for the site 120 triggers the platform 150 to automatically present the property manager with a series of corrective measures, and the system identifies and stores appropriate deadlines, task information, and related data for curing the condition.

The dynamic models 151 may include information that causes the platform 150 to execute a variety of actions for curing, mitigating, and/or remediating unfavorable conditions at the sites 120 and to generate logistical events 161 corresponding to these actions. In certain embodiments, dynamic models 151 can cause the platform 150 to control and utilize the remediation equipment 126 to cure or prevent unfavorable conditions at the sites 120. Generally speaking, the remediation equipment 126 can represent any device capable of providing assistance with preventing or correcting unfavorable conditions at a site 120. Exemplary remediation equipment 126 includes equipment for treating water (e.g., by treating the water with biocides, with filters, or in other ways), air, soil, or other environmental aspects at the sites 120. Other types of remediation equipment 126 can include facilities management equipment, such as automated snow removal devices, automated floor cleaning devices (e.g., autonomous robotic cleaners that scrub, vacuum, sweep, or otherwise clean floors), air filtering devices, and other types of automated facilities management devices.

In certain embodiments, the remediation equipment 126 includes one or more sensors 128 for monitoring conditions at the sites 120. Any type of sensor 128 can be used for monitoring the conditions. The remediation equipment 126 (and/or sensors 128) is in communication (e.g., via wired or wireless communication) with the platform 150, site servers 122, and/or monitoring equipment 124. The dynamic models 151 can specify that the remediation equipment 126 is to be activated automatically (e.g., in response to the monitoring equipment detecting an unfavorable condition) or in response to a platform user selecting activation options that are made available via the platform 150.

The logistics management applications 153 provide the user with controls (e.g., which are displayed on an interface of the user device 110) for activating/de-activating the remediation equipment 126 and for controlling the remediation equipment 126 in various ways. The logistics management applications 153 provide a customized set of controls for each device included with the remediation equipment 126, which take advantage of the hardware and functionality of devices. For example, if water treatment equipment is made available at a site 120, the logistics management applications 153 can provide a user with controls for selecting biocides and disinfectants to be administered, specifying levels of biocides or disinfectants to be applied, specifying filtration parameters, specifying maximum acceptable contaminant levels, and any other parameters associated with treating water. Likewise, if an autonomous floor cleaning device is provided at a site 120, the controls can allow locations that require cleaning to be specified, along with the type of cleaning (e.g., scrubbing cleanse, vacuum cleanse, soap cleanse, etc.) to be performed at the locations. Appropriate controls can be customized for each of the devices included in the remediation equipment 126.

The logistics platform 150 can be configured to generate various reports in both digital and print formats. The reports can be utilized to satisfy compliance and regulatory rules, to enable record-keeping at the sites, and/or for other reasons. The reports can provide summaries of the tasks that were performed at each of the sites 120 (e.g., indicating when the tasks were performed, who performed them, test results generated in carrying out the tasks, etc.). The reports can be transmitted over the network 190 to computing devices 110 and/or other third parties (e.g., governmental compliance entities).

In certain embodiments, such as those in which the logistics platform 150 is utilized to manage legionella conditions at the sites 120, the logistics platform 150 can be configured to generate a site report. The site report can represent a detailed report that is generated to ensure compliance with regulatory measures associated with maintaining cooling or water towers 121 and/or managing legionella conditions associated with cooling or water towers 121. For example, the site report can include various sections that include a year-to-date summary of site conditions, corrective actions that were undertaken to mitigate or prevent legionella in cooling or water towers 121, water testing results, and monitoring tasks. Because this detailed site report can be complicated and confusing to create, the documents (physical or digital) that are to be included in the report can be coded with specific color markings, or otherwise organized, to ensure that property managers place the documents in the proper sections of the report. The nodes of the dynamic models 151 can be used to specify the markings that are applied to each of the documents.

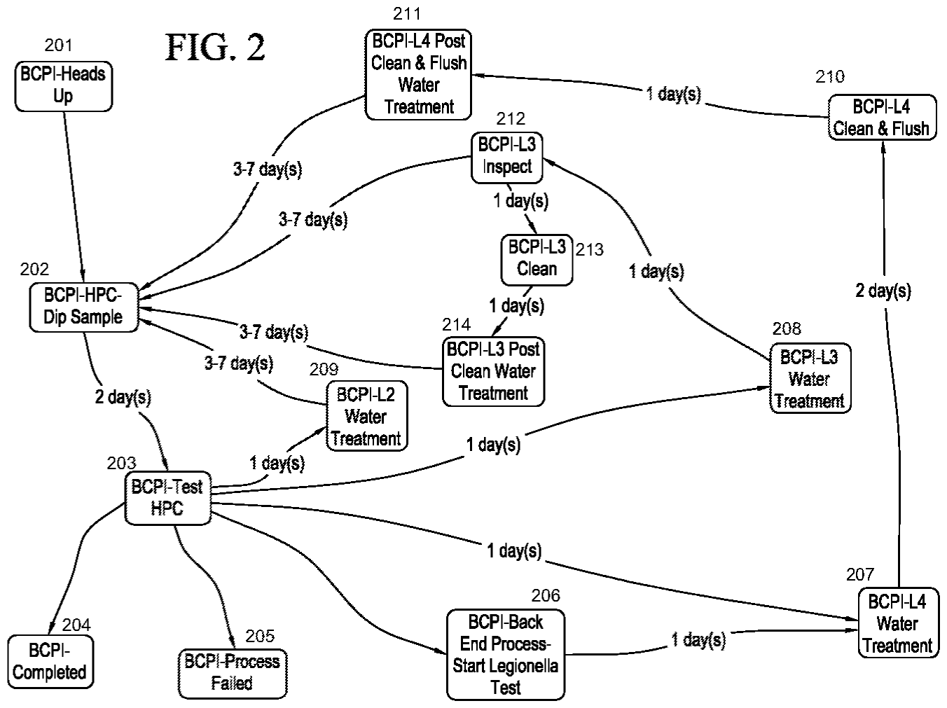

FIG. 2 is an exemplary node diagram utilized to represent a dynamic model generated by the logistics platform 150 according to certain embodiments. This exemplary node diagram provides a dynamic model 151 for controlling a workflow associated with handling legionella detection and testing at one or more sites (e.g., such as sites 120 in FIG. 1A). The node diagram can be created by a user (e.g., platform administrator or property manager) using the modeling tool 152. The modeling tool 152 may present one or more graphical user interfaces that can be utilized to define and edit the node diagram. Using the modeling tool 152, nodes are inserted into the diagram along with connectors that indicate how the workflow is to transition among the nodes. Each time a node is added, various criteria is associated with the node, e.g., such as inputs that are to be evaluated by the node and conclusion parameters that indicate how the workflow will proceed to other nodes. The criteria can also specify individuals (e.g., in-house employees or third-party vendors) who are responsible for performing, managing, or overseeing the tasks, and it can identify forms that allow those individuals to provide feedback associated with the tasks. The connectors between the nodes can indicate time frames for performing tasks.

The process illustrated in FIG. 2 begins in the top left corner at node 201 and proceeds to node 202 that represents a task for taking a water sample. The flow then proceeds to node 203 that represents a test is to be performed on the water sample. The transition between nodes 202 and 203 indicates that the test is to be performed within two days of taking the water sample. The test results of the water test will be received as inputs by node 203. The conclusion parameters specified for the node 203 will determine how the workflow will transition to one of six nodes (i.e., nodes 204-209) based on the test results received by the node 203.

If the tests results are favorable (e.g., indicating no presence of legionella or other hazardous conditions), then the workflow will proceed to node 204 and the process will end. If the tests results are inconclusive or an error occurs, the workflow will proceed to node 205, which indicates the process has failed. This may automatically restart the process. Otherwise, if the test results indicate that the water should be treated, the process can proceed to node 207, 208, or 209 based on the level of treatment required. For example, if minimal treatment is required, the workflow may proceed to node 209, which involves the task of water treatment and then back to node 202, which restarts the sampling and testing process. If greater levels of treatment are required, the workflow may proceed to paths associated with node 207 or node 208. If the workflow proceeds down either of these paths, the workflow may proceed to nodes indicating that a variety of tasks associated with corrective measures may be taken. The corrective measures can include tasks for treating, cleaning, and/or flushing the water (nodes 207, 208, 210, 211, 213, and 214) in the water towers, and scheduling inspections (node 212) with personnel responsible for ensuring compliance with applicable regulations. The paths or transitions connecting node 203 to nodes 207 and 208 ultimately lead back to node 202 where the sampling process is restarted.

If the testing performed at node 203 detects a likelihood of legionella, then the workflow proceeds to node 206. Transitioning of the workflow to node 206 will automatically initiate execution of a sub-model or child model that includes another node diagram that controls the specific workflow for testing and treating water for legionella. Depending upon the criteria specified for node 206, the execution of the sub-model or child model can be performed concurrently with the execution of the model shown in FIG. 2, or the workflow in FIG. 2 can be halted until the sub-model initiated by node 206 has completed.

As mentioned above, the dynamic models 151 (e.g., such as the one represented by the diagram in FIG. 2) can be integrated into, and utilized by, the logistics management applications 153 to automate workflows at the sites 120. The logistics management applications 153 can present appropriate interfaces to various stakeholders to permit the operations associated with the nodes to be carried out. For example, the interfaces may permit inputs to be provided that specify laboratory results pertaining to water tests (e.g., at node 202 and 206), confirm performance of water treatment operations (e.g., at nodes 207, 208, and 209), confirm performance of cleaning and/or flushing operations (e.g., at nodes 210, 211, 213, and 214), and/or confirm inspections were conducted (e.g., at node 212).

The criteria specified for the nodes may identify individuals (e.g., vendors, property managers, or employees) that are to perform the various tasks (e.g., treating, cleaning, and/or flushing tasks). The criteria can also specify if and when alerts 170 are to be sent to individuals associated with the workflow. The criteria may further specify inputs required or expected to be received at each node, and conclusion parameters for transitioning the workflow downstream to other nodes based on the inputs. As discussed in further detail below, other criteria may be associated with the nodes.

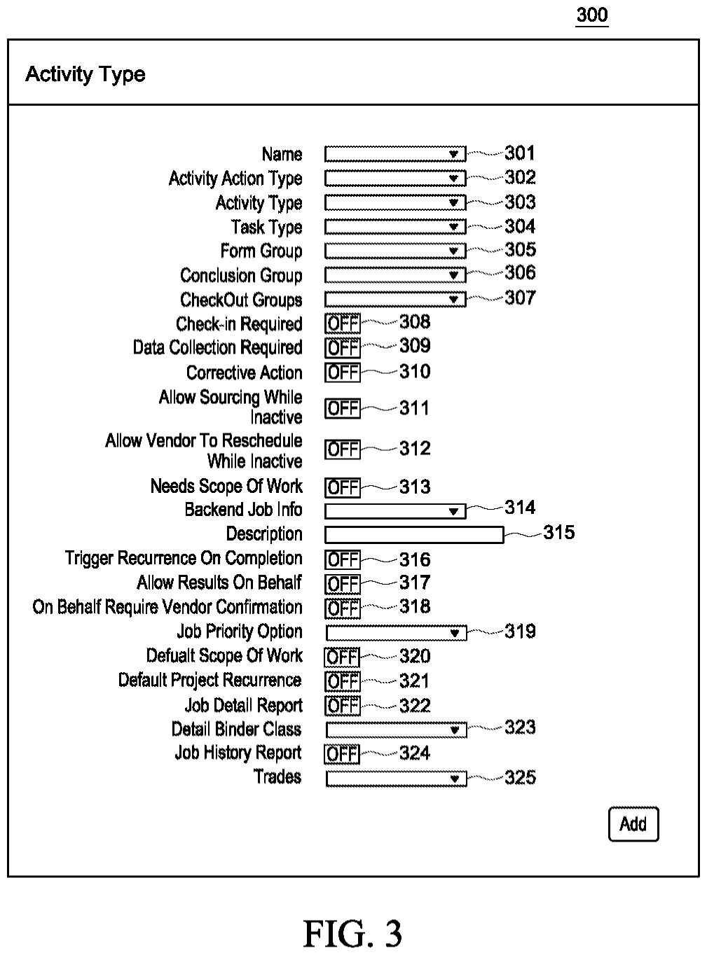

FIG. 3 is an exemplary interface 300 for defining node criteria and adding nodes to be inserted into a node diagram for a dynamic model according to certain embodiments. This interface 300 may be presented by the modeling tools 152 to a user that is creating or updating a dynamic model 151. When the user is finished specifying the criteria for the node, the user may select the “Add” button in the lower right corner of the interface and the node will be added to the dynamic model 151, and/or an existing node included in the dynamic model 151 may be updated. In certain embodiments, this may involve updating a visual representation of a node diagram (e.g., as shown in FIG. 2) to include the newly added node.

The exemplary interface 300 includes a plurality of different input fields (e.g., which can include drop-down menus, buttons, text fields, etc.) for specifying various criteria for the node being added. Each of these is discussed below.

A “name” field 301 permits a user to specify a name for the node being added. In certain embodiments, the interface may also include a second field that enables a user to specify a “short name” for the node being added. When either the name or the short name is updated on the backend of the system, the changes can be viewed instantly by vendors and other users who are utilizing the logistics management applications 153.

An “activity action type” field 302 permits a user to specify the type of node that is being added. Exemplary node types may include:
(1) Job=This node type indicates that a certain type of task is to be performed when workflow proceeds to the node. Exemplary tasks may include taking water samples, cleaning and treating water with biocides, cleaning water tower structures, draining and filling the tower structures, and performing maintenance on the tower structures. Nodes 202, 207, 208, 209, 210, 211, 213, and 214 are examples of job nodes.
(2) Test=This node type indicates that a test is to be performed when workflow proceeds to the node. For example, a test node may indicate that a laboratory is to conduct tests for detecting legionella or other biological/chemical contaminants. Node 203 in FIG. 2 is an example of a test node.
(3) Stop & Restart=This node type is a termination block, which causes the workflow to stop and start over from the beginning. Node 205 in FIG. 2 may represent a Stop & Restart node, which causes the workflow to stop and restart because of an error or inclusive test results.
(4) Activity Model Job=This node type terminates the process or workflow associated with the model, including all associated jobs that are currently ongoing, and initiates a new process or workflow by referencing a new specified activity model. This node type can be utilized to divert the current project or workflow to a completely new path (e.g., in the event that it is determined that the current workflow is unable to provide the desired outcome).
(5) Backend Project=This node type links to another model (e.g., a sub-model or child model). It activates a new process to be executed in connection with the workflow. The workflow associated with the other model may be executed concurrently with the model to which the node is being added. Node 206 in FIG. 2 is an example of a backend project node that activates a new workflow defined by a dynamic model 151 for testing or handling the detection of legionella.
(6) No Operation=This node type does not perform any operation or execute any job. For example, this type of node can be utilized to represent a final end node, which terminates or marks completion of the workflow. In certain circumstances, this can be utilized if a decision node directs the workflow to a decision branch that indicates the process should end.

An “activity type” field 303 indicates the type of function that is to be performed. For example, if the activity action type field 302 is defined to be a job node, the activity type field 303 may indicate which type of job is to be performed. For example, as mentioned above, the activity type field 303 may specify that that the job is for taking water samples, cleaning and treating water, cleaning water tower structures, draining and filling the tower structures, and performing maintenance on the tower structures. Similarly, if the activity action type field 302 is defined to be a test node, the activity type field 303 may indicate the type of test that is to be conducted.

A “task type” field 304 is used to specify one or more sub-tasks that are to be completed in connection with performing the function identified by activity type field 303. For example, if the selected activity type is for draining and filling water towers, the task type field 304 may specify that a vendor is to be scheduled to perform the draining and filling activities, and that the vendor is to provide feedback to the platform 150 confirming that the sub-tasks have been performed. Likewise, if the selected activity type is for cleaning and treating water, the task type field 304 can be utilized to specify a series of activities that are to be performed in connection with cleaning and treating water, and that the vendor or other individual is to provide feedback to the platform 150 confirming that the sub-tasks have been performed.

A “form group” field 305 permits a user to select an input form to be utilized in connection with the node. A user may customize the input form according to the specific needs of a site by adding fields requesting desired inputs. A vendor or other individual that is tasked with performing the tasks associated with the node can utilize the form to provide feedback (e.g., to confirm performance of activities, to specify parameters or values associated with performance of the activities, and/or to specify test results and other parameters). The form can be accessed via the logistics management applications 153. In certain embodiments, the form group field 305 can also be utilized to specify that the node is to receive inputs from the equipment (e.g., monitoring equipment 124, remediation equipment 126, and/or sensors 128) at the sites 120 in connection with performing tasks associated with the node.

A “conclusion group” field 306 specifies conclusion parameters, which indicate how the workflow will transition from the node. For example, as mentioned above with respect to FIG. 2, the workflow may transition from test node 203 to one of six different nodes based on the results of the water test (e.g., based on whether the test results fall in different ranges). The conclusion group field 306 may specify the parameters for selecting one of the six nodes based on the test results inputted to the node (e.g., based on the inputs identified or associated with the form group field 305).

A “checkout group” field 307 includes options for indicating statuses when a vendor or other individual is checking out of a node or during completion of the operation at the node. For example, the checkout group field 307 may indicate that the status of the job is to be “completed” or that the individual is “returning” to allow for further actions to be performed in connection with the tasks associated with the node.

A “check-in” field 308 indicates whether an individual (e.g., vendor or employee) is required to check-in prior to or during performance of the tasks associated with the node. For example, if this field is set to “yes,” then the individual may be required to check in to provide confirmation that the individual will handle the tasks associated with the node.

A “data collection” field 309 indicates whether or not inputs are required to be provided at the node. If this field is set to “yes” and the form group field 305 identifies an input source (e.g., an input form or equipment inputs), then the node will be configured to receive these inputs.

A “corrective action” field 310 indicates whether or not the node is associated with activities for providing a corrective action. This field can be used to trigger various types of corrective actions. For example, nodes 207 and 210 in FIG. 2 (which are associated with tasks for treating water and cleaning/flushing water towers) can be deemed to be corrective actions.

A “sourcing” field 311 indicates whether vendor sourcing for downstream nodes is permitted (e.g., to ensure time constraints are satisfied). If this field is set to “yes,” this permits vendors or other individuals to be assigned to perform tasks associated with downstream nodes.

A “rescheduling” field 312 indicates whether or not a vendor is permitted to reschedule performance of task for downstream nodes. Thus, if the sourcing field 311 and the rescheduling field 312 are both set to “yes,” then vendors can be sourced for downstream nodes and the vendors are permitted to reschedule performance of the activities.

A “scope of work” field 313 indicates whether or not a scope of work is required for the node. The scope of work can provide a detailed description of one or more tasks associated with the node, and can be utilized by vendors or other individuals in connection with executing or overseeing tasks associated with the node. In certain embodiments, a property manager or other individual can define the scope of work by accessing the platform and inputting associated information.

A “backend job” field 314 identifies another dynamic model 151 that is to be initiated and executed when the workflow transitions to the node. Node 206 in FIG. 2 is an example when the backend job field 314 for a node is set to identify a dynamic model 151 that is directed to activities associated with testing water samples for legionella. When the workflow transitions to node 206, the dynamic model 151 identified by the backend job field 314 will be executed, possibly in parallel with the model to which the node is being added. The backend job field 314 permits a plurality of dynamic models 151 to be linked together in various ways.

A “description” field 315 permits a user to input a textual description describing the node.

A “trigger recurrence on completion” field 316 permits a user to specify that the task associated with the node should once again be triggered upon completion of the task.

An “allow results on behalf” field 317 indicates that an administrator, employee, or other user associated with managing logistics platform 150 is permitted to supply inputs (e.g., results, feedback, or data) on behalf of a vendor. Certain tasks may require the vendor to supply the inputs, while other tasks can allow an administrator, employee, or other user to assist a vendor with supplying the inputs. This field allows the user to specify who has the ability to supply the inputs.

An “on behalf requires review” field 318 allows a user to specify whether or not a second administrator, employee, or other user associated with managing logistics platform 150 is required to review inputs entered (e.g., results, feedback, or data) on behalf of a vendor.

An “on behalf require vendor confirmation” field 319 allows a user to specify whether or not a vendor is required to confirm the inputs entered (e.g., results, feedback, or data) by an administrator, employee, or other user associated with managing logistics platform 150 on behalf of the vendor.

A “default scope of work” field 320 allows a user to specify whether or not a scope of work assigned to, or associated with, the current node is also to be assigned to, or associated with, other nodes or jobs that are spawned by the current node.

A “default project recurrence” field 321 allows a user to specify whether or not the current node will be used as a reference point (e.g., in terms of timing) for a project that is defined by an associated dynamic model 151. In certain embodiments, the first node added to the dynamic model is selected as the default project reference point.

A “job detail report” field 322 allows a user to specify whether or not a report is to be generated that provides details regarding performance of the tasks associated with the node. For example, the job detail report can indicate the types of tasks that were performed, when the tasks were performed, who performed the tasks, results and feedback associated with the tasks, whether or not the tasks were completed, and/or other related information.

A “detail binder class” field 323 allows a user to specify information that can be used to classify a job detail report that is generated. For example, a site report can include information on a wide variety of information (e.g., related to a year-to-date summary, corrective actions, site water testing, monitoring tasks, etc.). The classification information identified by this field can be used to easily identify the appropriate section of the site report in which the job detail report is to be inserted or appended.

A “job history report” field 324 allows a user to specify whether or not a cumulative report (e.g., a cumulative year-to-date summary) is to be generated for jobs or nodes having the same type assigned to the current node.

A “trade” field 325 allows a user to specify the vendor type(s) that is permitted to perform jobs that are associated with the node, or that are spawned from the node.

The exemplary input fields shown on the interface in FIG. 3 demonstrate examples of criteria that can be specified for nodes that are incorporated into the dynamic models 151 created using the logistics platform 150. However, it should be recognized that additional criteria can be added to the interface and/or other interfaces may be utilized to define additional characteristics and criteria for the node. In addition, while the interface shown in FIG. 3 includes fields that are primarily directed to adding nodes to a dynamic model 151 associated with managing workflows for legionella conditions, it should be recognized that the interface can be adapted to provide input fields that are utilized to specify criteria for other types of workflows (e.g., workflows associated with IFM obligations and/or other types of chemical/biological obligations).

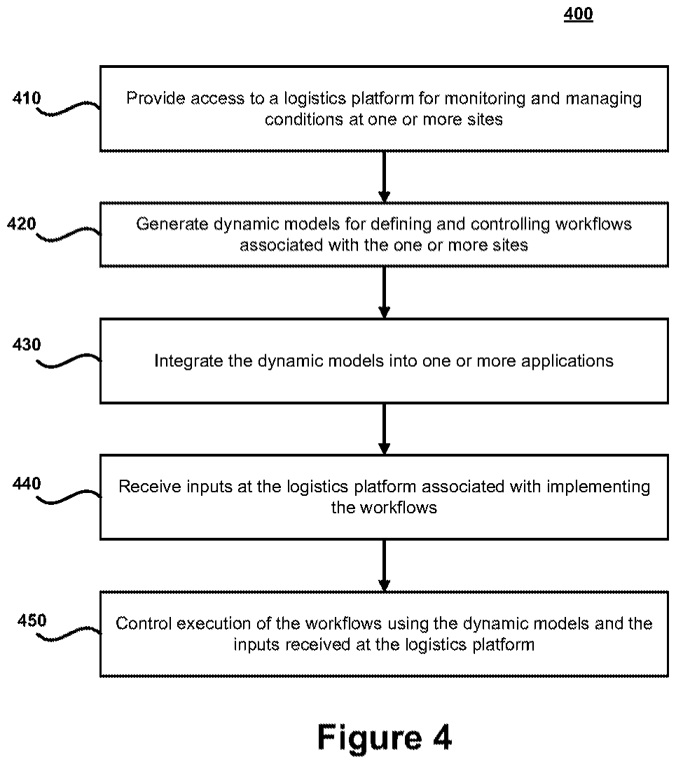

FIG. 4 illustrates a flow chart for a method 400 according to certain embodiments. Method 400 is merely exemplary and is not limited to the embodiments presented herein. Method 400 can be employed in many different embodiments or examples not specifically depicted or described herein. In some embodiments, the steps of method 400 can be performed in the order presented. In other embodiments, the steps of method 400 can be performed in any suitable order. In still other embodiments, one or more of the steps of method 400 can be combined or skipped. In many embodiments, system 100 and/or logistics platform 150 can be suitable to perform method 400 and/or one or more of the steps of method 400. In these or other embodiments, one or more of the steps of method 400 can be implemented as one or more computer instructions configured to run at one or more processor devices and configured to be stored on one or more non-transitory memory storage devices. Such processor devices and/or non-transitory memory storage devices can be part of a computer system, such as system 100, platform hosting device 130, and/or site servers 122.

In step 410, access is provided to a logistics platform (e.g., logistics platform 150) for monitoring and managing conditions at one or more sites 120. The sites may represent residential, commercial, industrial, and/or governmental buildings or properties. The logistics platform can be configured to provide assistance with monitoring, managing, and remediating various types of conditions, such as hazardous biological/chemical conditions or facilities management conditions. In certain embodiments, the logistics platform can be configured to provide assistance with monitoring, managing, and remediating conditions involving legionella at the one or more sites 120. Various individuals (e.g., platform administrators, employees, vendors, property managers, etc.) may be permitted to access the logistics platform using a variety of computing devices 110 (e.g., desktop computers, laptop computers, mobile devices, tablet devices, wearable devices, etc.).

In step 420, dynamic models 151 are generated for defining and controlling workflows associated with the one or more sites 120. The dynamic models 151 can be created using modeling tools 152 that are accessible via the logistics platform. In certain embodiments, administrators or individuals associated with hosting the logistics platform can create customized dynamic models 151 for each site 120 to accommodate the specific needs at the sites 120. The modeling tools 152 can provide one or more interfaces that enable the dynamic models 151 to be defined. This can include customizing nodes associated with the dynamic models 151 (e.g., using interface 300 in FIG. 3) and transitions that connect the nodes. Each site 120 can utilize multiple dynamic models 151 to customize workflows for various operations (e.g., workflows for legionella prevention, workflows for IFM specific operations, etc.). In certain embodiments, the dynamic models 151 can be implemented in software and can be stored on the logistics platform.

In step 430, the dynamic models 151 are integrated into one or more applications (e.g., such as logistics management applications 153). Integrating the dynamic models 151 into the one or more applications can include associating the dynamic models 151 with accounts for the sites 120 and/or making the dynamic models 151 available for use with certain accounts. This can be accomplished on the backend of the logistics platform by an administrator or other user. Once a dynamic model 151 is integrated, a user associated with the site 120 can utilize the applications to control a workflow at the site 120 based on the dynamic model 151.

In step 440, inputs are received at the logistics platform associated with implementing the workflows. The inputs may be received from monitoring equipment 124 (e.g., which can include sensors that enable real-time tracking of the hazardous biological or chemical conditions at the plurality of sites) and/or computing devices 110 (e.g., which include the applications that enable vendors, administrators, and other users to provide feedback, test results, assessments, and other information related to the conditions at the plurality of sites). The inputs can also be received from remediation equipment 126 (e.g., to indicate the status and/or results of a remediation task). The inputs can be received by the logistics platform over a network 190.

In step 450, execution of the workflows is controlled using the dynamic models 151 and the inputs received at the logistics platform. For example, as a workflow is handled at a site 120, the dynamic models 151 can utilize the inputs to guide the process of handling the workflow. As the workflow is executed, the workflow can transition to specific nodes included in the dynamic models 151. Some or all of the nodes can be associated with specific tasks that are to be carried out and can require certain inputs to be provided to assess the statuses of the tasks and to ensure that tasks are properly carried out.

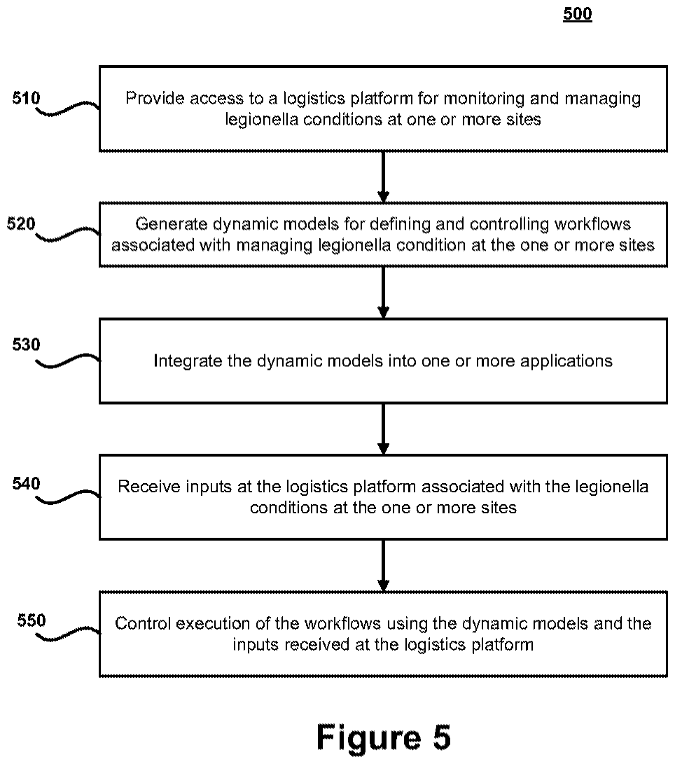

FIG. 5 illustrates a flow chart for a method 500 according to certain embodiments. Method 500 is merely exemplary and is not limited to the embodiments presented herein. Method 500 can be employed in many different embodiments or examples not specifically depicted or described herein. In some embodiments, the steps of method 500 can be performed in the order presented. In other embodiments, the steps of method 500 can be performed in any suitable order. In still other embodiments, one or more of the steps of method 500 can be combined or skipped. In many embodiments, system 100 and/or logistics platform 150 can be suitable to perform method 500 and/or one or more of the steps of method 500. In these or other embodiments, one or more of the steps of method 500 can be implemented as one or more computer instructions configured to run at one or more processor devices and configured to be stored on one or more non-transitory memory storage devices. Such processor devices and/or non-transitory memory storage devices can be part of a computer system such as system 100, platform hosting device 130, and/or site servers 122.

In step 510, access is provided to a logistics platform (e.g., logistics platform 150) for monitoring and managing legionella conditions at one or more sites 120. Each of the sites can include one or more cooling or water tower structures 121, and the logistics platform can provide assistance with preventing legionella from developing in the cooling or water tower structures 121 and/or eliminating legionella that has developed in the cooling or water tower structures 121. The sites may represent residential, commercial, industrial, and/or governmental buildings or properties. Various individuals (e.g., platform administrators, employees, vendors, property managers, etc.) may be permitted to access the logistics platform using a variety of computing devices 110 (e.g., desktop computers, laptop computers, mobile devices, tablet devices, wearable devices, etc.).

In step 520, dynamic models 151 are generated for defining and controlling workflows associated with managing legionella conditions at the one or more sites 120. The dynamic models 151 can be created using modeling tools 152 that are accessible via the logistics platform. In certain embodiments, administrators or individuals associated with hosting the logistics platform can create customized dynamic models 151 for each site 120 to accommodate the specific needs at the sites 120. The modeling tools 152 can provide one or more interfaces that enable the dynamic models 151 to be defined. This can include customizing nodes associated with the dynamic models 151 (e.g., using interface 300 in FIG. 3) and transitions that connect the nodes. Each site 120 can utilize multiple dynamic models 151 to customize workflows for various tasks related to managing the legionella conditions. For example, a first dynamic model 151 can be created to manage operations associated with maintaining the cooling or water tower structures 121; a second dynamic model 151 can be created to manage operations associated with treating the water in the cooling or water tower structures 121; and a third dynamic model 151 can be created for handling situations in which legionella is detected in the cooling or water tower structures 121. Dynamic models 151 can be created for many other types of workflows.

In step 530, the dynamic models 151 are integrated into one or more applications (e.g., such as logistics management applications 153). Integrating the dynamic models 151 into the one or more applications can include associating the dynamic models 151 with accounts for the sites 120 and/or making the dynamic models 151 available for use with certain accounts. This can be accomplished on the backend of the logistics platform by an administrator or other user. Once a dynamic model 151 is integrated, a user (e.g., vendor or property manager) associated with the site 120 can utilize the applications to control a workflow at the site 120 based on the dynamic model 151.

In step 540, inputs are received at the logistics platform associated with the legionella conditions at the one or more sites 120. The inputs may be received from monitoring equipment 124 at the sites 120. For example, one or more of the sites 120 may include monitoring equipment 124 that includes sensors 128 which enable real-time tracking of the legionella conditions at the plurality of sites. For example, the sensors may be used to indicate pH levels of water, water temperature, and/or presence of biological agents. The monitoring equipment 124 can communicate with the logistics platform over a network 190 to indicate whether or not legionella has been detected in the cooling or water towers 121 and/or whether or not conditions are susceptible to developing legionella. The inputs can also be received from remediation equipment 126. For example, one or more of the sites can include remediation equipment 126 that applies biocides, chemicals, and/or other substances to eliminate or prevent the development of legionella in the one or more cooling towers. The remediation equipment 126 can communicate with the logistics platform over a network 190 to provide information related to the substances applied (e.g., to indicate the types of substances applied, the amounts applied, when they were applied, etc.). The inputs can also be received from computing devices 110. For example, as tasks are performed at the sites 120 for implementing the workflows, the individuals (e.g., vendors, property managers, etc.) that perform the tasks can provide information to the logistics platform. The information can include feedback, test results, assessments, and/or other information related to the conditions at the plurality of sites 120 or the tasks performed at the sites 120.

In step 550, execution of the workflows is controlled using the dynamic models 151 and the inputs received at the logistics platform. For example, as a workflow is handled at a site 120, the dynamic models 151 can utilize the inputs to guide the process of handling the workflow. As the workflow is executed, the workflow can transition to specific nodes included in the dynamic models 151. Some or all of the nodes can be associated with specific tasks that are to be carried out and can require certain inputs to be provided to assess the statuses of the tasks and to ensure that tasks are properly carried out.

As workflows are executed with the assistance of the platform 150, large quantities of logistical events 161 may be generated or detected using the dynamic models and/or other features of the platform 150. The logistical events 161 may correspond to pending tasks, deadlines, and/or other events associated with the sites 120. For example, with respect to controlling legionella conditions at a single site 120, the platform 150 may generate or detect logistical events 161 corresponding to tasks associated with periodically inspecting cooling or water towers 121 at the site 120, treating water in the cooling or water towers 121, sending water samples for laboratory testing, draining the cooling or water towers 121, cleaning structures of the cooling or water towers 121, performing maintenance on the cooling or water towers 121, and/or periodically filing reports or paperwork with government agencies related to management of the legionella conditions. At that same site 120, other types of logistical events 161 may arise related to managing or controlling biological conditions (e.g., managing mold, insects, and/or bacterial conditions at the site 120), chemical conditions (e.g., managing asbestos, lead, and/or radon conditions at the site 120), and/or IFM conditions (e.g., managing interior and/or exterior property services at the site 120). Executing the logistical events 161 generated or detected by the platform 150 can be extremely complex given the coordination that may be required among the various stakeholders and the deadlines to complete the tasks.

The complexity of executing the logistical events 161 can grow drastically in scenarios where multiple sites 120 (e.g., dozens, hundreds, or even thousands of sites 120) are being managed. Multiple logistical events 161 may arise daily for each of the sites 120, and each of the logistical events 161 is expected to be handled by a particular stakeholder (e.g., vendor, service provider, or property manager) within a particular time frame. Due to the large volume of logistical events 161, it can be extremely difficult to ensure the timely scheduling and completion of the tasks corresponding to the logistical events 161. Additionally, it is also extremely difficult to ensure that all stakeholders are communicated with in an efficient and effective manner, which can be very complicated in scenarios in which certain stakeholders are responsible for managing unrelated logistical events at separate sites 120.

In certain embodiments, one or more task execution individuals can provide assistance with ensuring that the logistical events 161 associated with each of the sites 120 are performed in a timely manner and/or in compliance with applicable regulations or policies. The task execution individuals may correspond to platform administrators, property managers, and/or other individuals who are capable of overseeing, managing, and/or assisting with the execution of the logistical events. The task execution individuals can communicate with stakeholders (e.g., vendors, service providers, property managers, etc.) to provide assistance with executing the tasks corresponding to logistical events.

For example, as logistical events 161 are identified by the platform 150 (e.g., in response to information received from vendors, sensory feedback from monitoring equipment 124, etc.), the task execution individuals can monitor the progress of any tasks corresponding to the logistical events 161, and communicate with appropriate stakeholders to provide assistance with scheduling and/or executing the tasks. However, as the number of logistical events increases, the ability to allocate tasks among the task execution individuals becomes difficult, and each task execution individual's ability to communicate with the various stakeholders in an efficient and concise manner becomes more complex. For example, simply placing the logistical events 161 in a queue and handling them one at a time may result in a single stakeholder receiving a multitude (e.g., dozens or hundreds) of separate communications (e.g., alerts, notifications, phone calls, messages, and/or e-mails) each day related to each separate logistical event 161 that pertains to the stakeholder. This can result in stakeholders ignoring such communications, thus increasing the risk that tasks associated with logistical events 161 are not completed in a timely fashion and/or are completed in a manner that is not compliant with applicable regulations or policies.

To overcome the aforementioned challenges, the platform 150 can include a channel allocation component 160 that provides assistance with handling large quantities of logistical events 161 across multiple sites 120. As explained in further detail below, the channel allocation component 160 can group logistical events into separate channels based on certain relationships or grouping criteria 163, and can allocate the channels to task execution individuals who oversee and manage execution of the logistical events. The functions performed by the channel allocation component 160 provide assistance with facilitating the timely scheduling and completion of tasks, and communicating with appropriate stakeholders in an efficient and non-redundant manner. Rather than overwhelming the stakeholders with a multitude of separate communications, the management of logistical events 161 can be grouped into bundles that can be handled together.

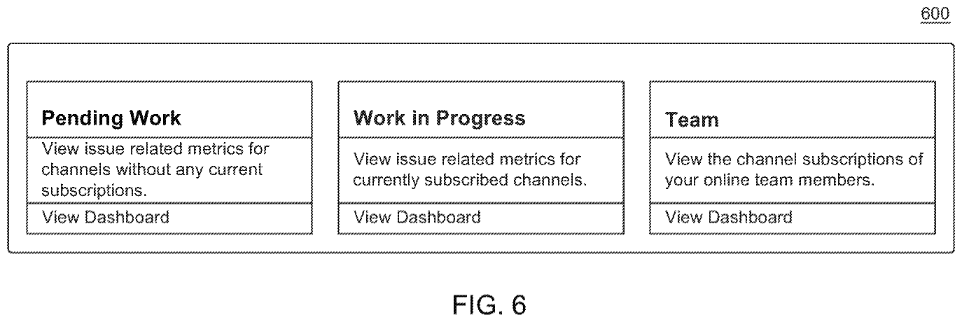

FIGS. 6-11 illustrate exemplary interfaces that can be provided by a channel allocation component 160 according to certain embodiments. These interfaces may represent graphical user interfaces (GUIs) that are accessed via the logistics management applications 153 and/or other functions provided by the platform 150. The GUIs can be displayed to task execution individuals on computing devices 110. As explained in further details below, the channel allocation component 160 can assist the grouping of logistical events into “channels” based on certain relationships or grouping criteria 163, and assigning the channels 162 to the task execution individuals. The manner in which the channel allocation component 160 performs these functions enables the task execution individuals to easily oversee the execution of the logistical events and to communicate with appropriate stakeholders in an effective and concise manner.

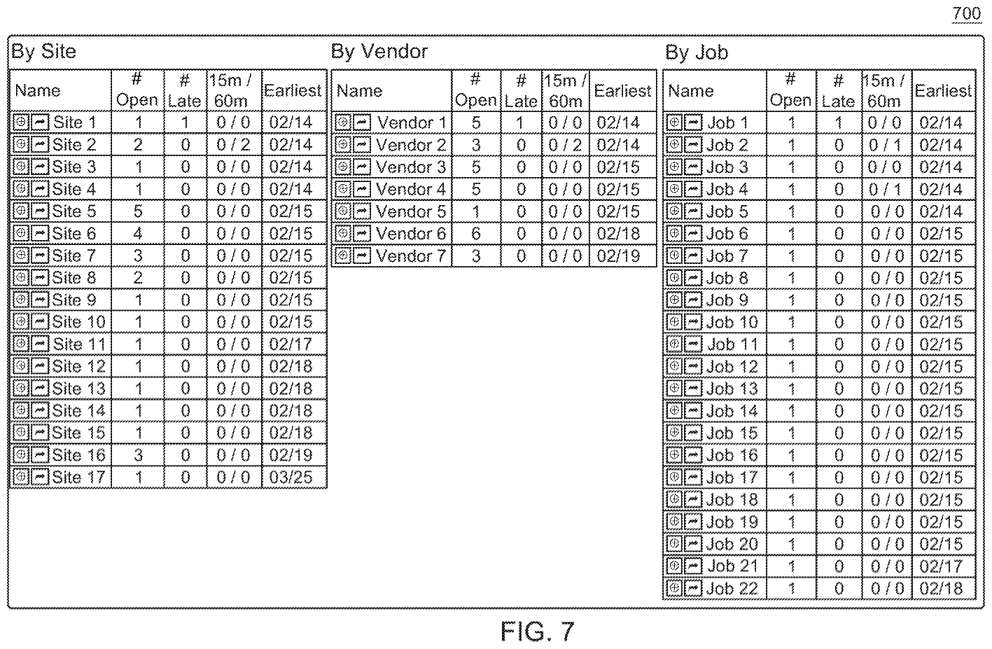

FIG. 6 is an exemplary interface 600 that displays a menu comprising three options: a first option 610 labeled “Pending Work”; a second option 620 labeled “Work in Progress”; and a third option 630 labeled “Team.” The interface 600 may be displayed as a GUI on a user device 110 operated by a task execution individual who is authorized to access the channel allocation component 160 on the platform 150. Selecting the first option 610 causes the user device 110 to navigate to an interface (e.g., interface 700 in FIG. 7) that displays channels 162 that have not yet been assigned to a task execution individual, and which enables the channels 162 to be assigned to task execution individuals. Selecting the second option 620 causes the user device 110 to navigate to another interface that displays information related to the statuses of pending logistical events 161 and/or channels 162 that have been assigned to task execution individuals. Selecting the third option 630 causes the user device 110 to navigate to another interface that displays the channels 162 that have been assigned to each of the task execution individuals. The interface displayed by selecting the third option permits the workloads of the task execution individuals to be monitored and reallocated.

FIG. 7 is an exemplary interface 700 that displays a listing of channels 162 that have not been assigned to a task execution individual. The interface 700 includes three sections: a site section 710; a vendor section 720; and a job section 730. Each of these tables includes a listing of channels 162 that can be assigned to task execution individuals. Each channel 162 may be associated with, and include, information related to one or more logistical events 161 to be executed. The logistical events are grouped in separate ways in each of the three sections as explained below.

The site section 710 lists includes a table or listing of channels 162 each of which corresponds to a separate site 120. The platform 150 provides assistance with executing logistical events 161 at each of the sites 120 included in the table or listing. The channels 162 in the site section 710 utilize grouping criteria 163 to merge or organize the logistical events 161 for each site 120 into a separate channel 162. Each row in the table corresponds to a separate channel 162, and each channel 162 in the site section 710 clusters or groups logistical events on a per site basis. Assigning a channel 162 in the site section 710 to a task execution individual will associate all logistical events 161 of the corresponding site 120 with the task execution individual. After a channel 162 is assigned to a task execution individual, all of the other task execution individuals can view such assignment, thus notifying them that the assigned task execution individual will be responsible for providing assistance with executing, managing, and/or handling the logistical events 161 associated with the corresponding site 120. For example, the task execution individual assigned to the channel 162 may then be responsible for assisting with the timely scheduling and/or completion of the logistical events 161 and corresponding tasks. In certain embodiments, after a channel 162 is assigned to a task execution individual, the channel 162 no longer appears on the interface 700 associated with the Pending Work option 610 and, instead, appears in an interface associated with the Work in Progress option 620.

For example, if the channel for “Site 1” is assigned to a task execution individual, then all uncompleted logistical events 161 (e.g., which may correspond to tasks for draining water towers, scheduling snow removal, etc.) associated with Site 1 are assigned to, and associated with, the task execution individual. In the event that the task execution individual notices that certain logistical events are not being attended to in a timely manner at the site 120, the task execution individual can take appropriate actions (e.g., communicate with those vendors/service providers, find alternative vendors/service providers, activate remediation equipment, etc.) to facilitate timely scheduling and completion of the logistical events 161.

As used herein, a user that has been assigned to a channel 162 is considered “subscribed” to the channel. A task execution individual can subscribe or assign herself or himself to a channel 162 by selecting a first subscribe option 760 on the left-most position in each row. A task execution individual can subscribe or assign a different task execution individual to a channel 162 by selecting a second subscribe option 740 located adjacent to the first subscribe option 760.

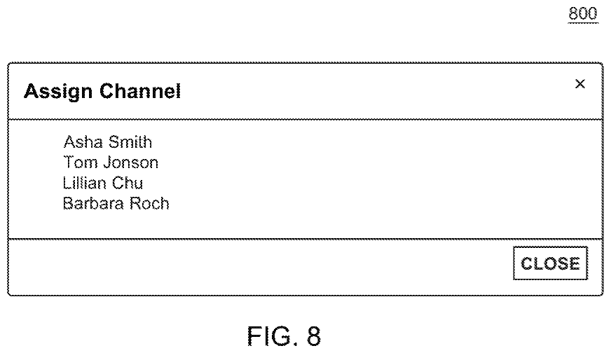

FIG. 8 is an exemplary interface 800 that may be displayed in response to selecting the second subscribe option 740. In certain embodiments, the interface 800 may be presented as a pop-up window or overlay that appears when the second subscribe option 740 is selected for a channel 162. The interface 800 includes a listing of task execution individual names. One or more of the task execution individual names may be selected in order to assign one or more task execution individuals to the corresponding channel 162.

Returning to FIG. 7, the site table in the site section 710 includes five columns. The “Name” column includes a name or identifier associated with each site 120, along with a first subscribe option 760 and second subscribe option 770 for assigning one or more task execution individuals to corresponding channels 162 associated with each of the sites 120. The “#Open” column indicates the number of uncompleted logistical events 161 at each site 120. The “#Late” column indicates the number of logistical events 161 that are past due or not completed on time at each site 120. The column labeled “15m/60m” indicates how many logistical events 161 at each site 120 should be completed within the fifteen minutes or sixty minutes in order to be completed in a timely fashion. For example, with respect to the channel for “Site 2,” the column includes “0/2,” which means that 0 tasks are due to be completed in the next fifteen minutes and 2 tasks are due to be completed in the next sixty minutes. The column labeled “Earliest” indicates the earliest date that an logistical event 161 is due to be completed at each of the sites. For example, while a site 120 may have many logistical events 161 that require completion, the date of the logistical event 161 having the closest deadline or due date may be listed in this column.

Each of the channels 162 included in the site section 710 can be selected to view detailed information related to the channels 162. For example, selecting a channel 162 included in the site section 710 can display information pertaining to the pending logistical events 161 at the corresponding site 120 and/or the vendors who service the site 120.

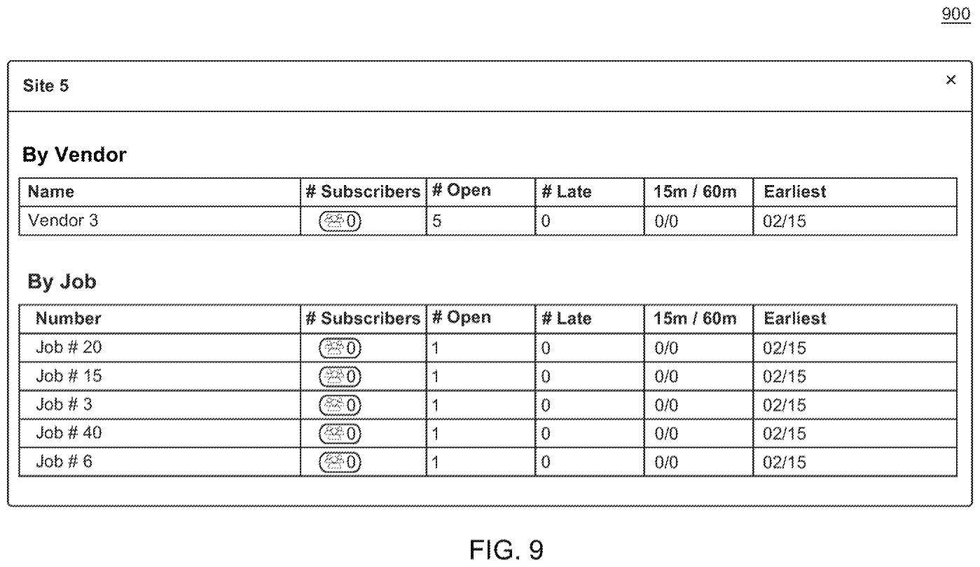

FIG. 9 discloses an exemplary interface 900 that may be displayed in response to selecting a channel 162 included in the site section 710 according to certain embodiments. In this exemplary interface 900, the channel 162 corresponding to “Site 5” has been selected. Similar interfaces can be displayed in response to selecting the other channels 162 in the site section 710.

The interface 900 includes a first table 910 that lists any vendors that are associated with, or assigned to, the site 120 corresponding to the selected channel 162, and a second table 920 that lists the logistical events 161 to be performed at the site 120. The vendors listed in the first table 910 are responsible for executing some or all of the logistical events 161 that arise at the site 120.

The “#Subscribers” column indicates whether any of the vendors included in the first table 910 or any of logistical events 161 included in the second table 920 have been assigned to task execution individuals. In this example, task execution individuals have not been assigned to any of the vendors or logistical events 161 at the site 120, which is indicated by the “0” in the column cells. However, if there had been one or more task execution individuals assigned to either the vendors or tasks, a view subscriber option 930 can be selected to view the assigned task execution individuals. This feature can be useful because it permits a task execution individual who is seeking to subscribe to a channel 162 for a site 120 to know whether other task execution individuals are subscribed to particular logistical events 161 associated with the site 120 and/or particular vendors who service the site 120. This knowledge can help to avoid excessive or redundant communications to the vendors and other stakeholders associated with the site 120.

The columns labeled “#Open,” “#Late,” “15m/60m,” and “Earliest” denote similar information as described above. However, in FIG. 9, this information is shown at a more granular level for each vendor (in the first table 910) and each logistical event (in the second table 920).

Returning to FIG. 7, the vendor section 720 includes a table of channels 162, each of which corresponds to a vendor that is utilized to service one or more sites 120 being managed by the platform 150. The vendors may correspond to service providers, property managers, stakeholders, and/or other individuals who assist with executing logistical events or corresponding tasks at the sites 120 (e.g., who assist with managing biological, chemical, and/or IFM conditions at the sites 120). The channels 162 in the vendor section 720 utilize grouping criteria 163 to merge or organize the logistical events 161 for each vendor into a separate channel 162. Each row in the table corresponds to a separate channel 162, and each channel 162 in the vendor section 720 clusters or groups logistical events 161 on a per vendor basis. Assigning a channel 162 in the vendor section 720 to a task execution individual will associate all logistical events 161 to be executed by a particular vendor 120 with the task execution individual. Once a channel is assigned to a task execution individual, all of the other task execution individuals can view such assignment, thus notifying them that the assigned task execution individual will be responsible for providing assistance with executing, managing, and/or completing the logistical events 161 affiliated with the vendor. The task execution individual assigned to the channel 162 may then be responsible for assisting with the timely scheduling and/or completion of those logistical events 161 corresponding to the vendor.

For example, if the channel for “Vendor 1” is assigned to a task execution individual, then all logistical events 161 associated with Vendor 1 may be assigned to, and associated with, the task execution individual. In the event that the task execution individual notices that certain logistical events 161 are not being attended to in a timely manner by a vendor, then the task execution individual can take appropriate actions to facilitate timely scheduling and completion of the logistical events 161 (e.g., by contacting the vendor and/or finding another vendor to handle certain tasks).

The vendor table in the vendor section 720 includes five columns. The “Name” column includes a name or identifier associated with each of the vendors, along with a first subscribe option 760 and second subscribe option 770 for subscribing task execution individuals to corresponding channels 162. The “#Open” column indicates the number of uncompleted logistical events associated with each vendor. The “#Late” column indicates the number of logistical events 161 that are past due and/or not completed on time by the vendor. The column labeled “15m/60m” indicates how many logistical events 161 should be completed by the vendor within the fifteen minutes or sixty minutes in order to be completed in a timely fashion. The column labeled “Earliest” indicates the earliest date that a logistical event 161 is due to be completed by the vendor. For example, while a vendor may be responsible for performing various logistical events 161 at different sites 120, the date of the logistical event 161 having the closest deadline may be listed in this column.

Each of the channels 162 included in the vendor section 720 can be selected to view detailed information related to the channels 162. For example, selecting a channel 162 included in the vendor section 720 may display information pertaining to the logistical events 161 that the vendor is responsible for handling and/or the sites 120 that the vendor services.

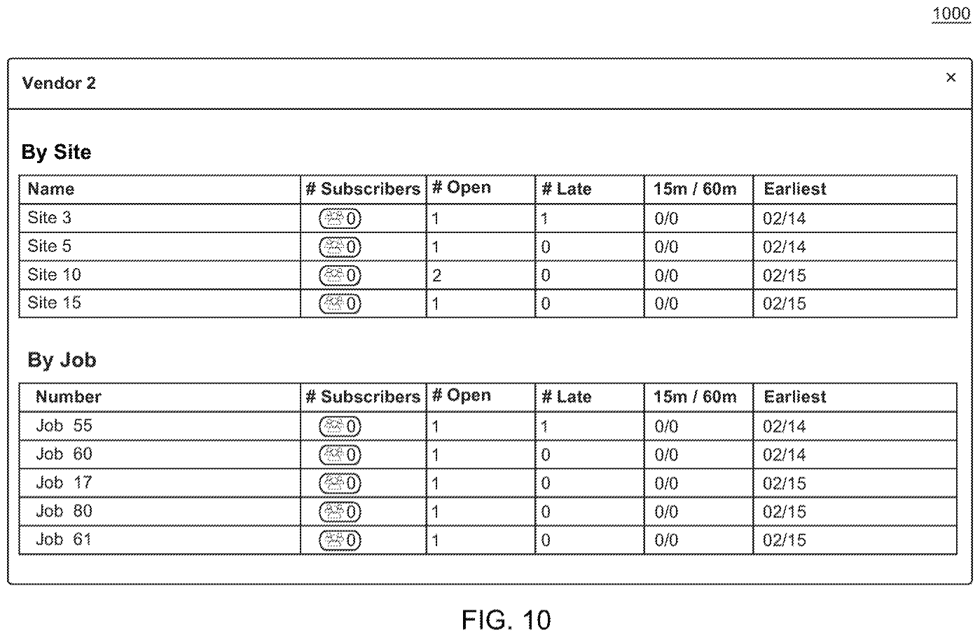

FIG. 10 discloses an exemplary interface 1000 that may be displayed in response to selecting a channel 162 included in the vendor section 720 according to certain embodiments. In this exemplary interface 1000, the channel 162 corresponding to “Vendor 2” has been selected. Similar interfaces can be displayed in response to selecting the other channels 162 in the vendor section 720.

The interface 1000 includes a first table 1010 that lists any sites 120 that are associated with, or assigned to, the vendor, and a second table 1020 that lists the logistical events 161 to be handled by the vendor. Similar to FIG. 9, the “#Subscribers” column indicates whether any of the sites listed in the first table 1010 and any of the logistical events 161 listed in the second table 1020 have been assigned to task execution individuals. View subscriber options 930 can be selected to view the assigned task execution individuals. Again, this can be useful because it permits a task execution individual who is seeking to subscribe to a channel 162 for a vendor to know whether other task execution individuals are subscribed to particular logistical events 161 and/or particular sites 120 that are serviced by the vendor, thus enabling avoidance of excessive or redundant communications to the vendor and other stakeholders.

The columns labeled “#Open,” “#Late,” “15m/60m,” and “Earliest” denote similar information as described above. However, in FIG. 10, this information is shown at a more granular level for each site (in the first table 1010) and each logistical event (in the second table 1020).

Returning to FIG. 7, the job section 730 includes a table of channels 162 corresponding to logistical events to be executed, managed, and/or completed at the sites 120 being managed by the platform 150. As explained above, the types of logistical events can vary greatly and may include tasks associated with managing legionella conditions at the sites 120. The logistical events 161 may additionally, or alternatively, include logistical events 161 associated with managing other types of biological conditions, chemical conditions, and/or IFM conditions at the sites 120. The channels 162 in the job section 730 utilize grouping criteria 163 to group or organize the logistical events 161 for job or task into a separate channel 162. Each row in the table corresponds to a separate channel 162, and each channel 162 in the job section 730 can correspond to a specific logistical event 161. Assigning a channel 162 in the job section 730 to a task execution individual will associate the corresponding logistical event 161 with the task execution individual. Once a channel 162 is assigned to a task execution individual, all of the other task execution individuals can view such assignment, thus notifying them that the assigned task execution individual will be responsible for providing assistance with executing the logistical event. The task execution individual assigned to the channel 162 may then be responsible for assisting with the timely scheduling and/or completion of the task.

For example, if the channel for Job 1 is assigned to a task execution individual, then the logistical event 161 associated with Job 1 may be assigned to, and associated with, the task execution individual. In the event that the task execution individual notices the logistical event 161 is not being attended to in a timely manner, then the task execution individual can take appropriate actions to facilitate timely scheduling and completion of the logistical event 161.

The job table in the job section 730 includes five columns. The “Name” column includes a name or identifier associated with a task, along with a first subscribe option 760 and second subscribe option 770 for subscribing or assigning task execution individuals to corresponding channels 162. The “#Open” column indicates the number of uncompleted tasks associated with each logistical event 161. In certain embodiments, each logistical event 161 may comprise a plurality of sub-tasks and the number in this column may indicate the total number of sub-tasks that are not completed. The “#Late” column indicates the number of tasks or sub-tasks associated with each channel that are past due and/or not completed on time. The column labeled “15m/60m” indicates how many tasks or sub-tasks should be completed within the upcoming fifteen minutes or sixty minutes in order to be completed in a timely fashion. The column labeled “Earliest” indicates the earliest date that a task or sub-task is due to be completed in a timely fashion.

Each of the channels 162 included in the job section 730 can be selected to view detailed information related to the channels 162. For example, selecting a channel 162 included in the job section 730 may display information pertaining to the vendor or vendors who are responsible for handling the tasks or sub-tasks corresponding to the channel 162 and/or the site 120 associated with the logistical event.

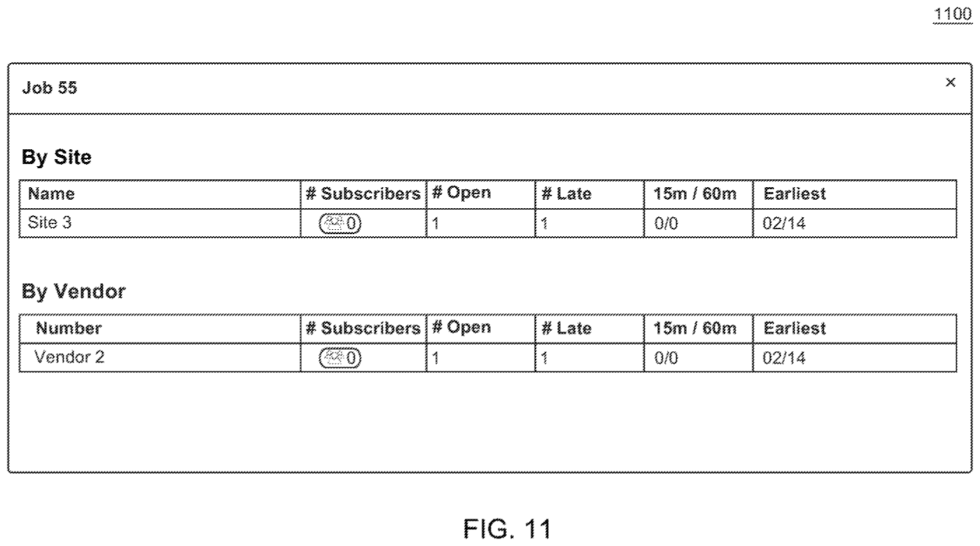

FIG. 11 discloses an exemplary interface 1100 that may be displayed in response to selecting a channel 162 included in the job section 730 according to certain embodiments. In this exemplary interface 1100, the channel 162 corresponding to “Job 55” has been selected. Similar interfaces can be displayed in response to selecting the other channels 162 in the job section 730.

The interface 1100 includes a first table 1110 that lists any sites 120 that are associated with the logistical event 161 (or corresponding tasks and sub-tasks), and a second table 1120 that lists any vendors that are responsible for performing the tasks or sub-tasks. Similar to FIGS. 9-10, the “#Subscribers” column indicates whether any of the sites or vendors in the first table 1110 and second table 1120 have been assigned to task execution individuals. View subscriber options 930 can be selected to view the assigned task execution individuals. Again, this can be useful because it permits a task execution individual who is seeking to subscribe to a channel 162 for a particular logistical event 161 to know whether other task execution individuals are subscribed to vendors and/or sites 120 associated with the logistical event, thus enabling avoidance of excessive or redundant communications to the vendors and other stakeholders.

The columns labeled “#Open,” “#Late,” “15m/60m,” and “Earliest” denote similar information as described above. However, in FIG. 11, this information is shown at a more granular level for each site (in the first table 1110) and each vendor (in the second table 1120).

The channels 162 displayed by the channel allocation component (e.g., in the site section 710, vendor section 720, and job section 730) may be ordered in various ways. In certain embodiments, the channels 162 may be ordered based on the urgency of completing the logistical events 151. For example, the channels 162 may be ordered based on the dates and/or times that the earliest logistical events 161 associated with the channels are due to be completed. In certain embodiments, any channels 162 associated with one or more logistical events that are late or past due (e.g., as indicated by the “#Late” columns) may be included at the top of the tables, followed by the channel 162 associated with an logistical event 161 having the earliest upcoming due date, followed by the channel 162 associated with an logistical event 161 having the second earliest upcoming due date, and so on. In certain embodiments, this may involve ordering the channels based on the information in the “#Late,” “15m/60m,” and/or “Earliest” columns. The channels 162 may be ordered in other ways as well.

In certain embodiments, the channel allocation component 160 can be configured to automatically assign or subscribe task execution individuals to the channels 162. The manner in which the channel allocation component 160 assigns or subscribes channels 162 to task execution individuals can vary. In certain embodiments, the channel allocation component 160 assigns the channels 162 to the task execution individuals based on the workloads of the task execution individuals who are currently logged into the platform 150. For example, the task execution individual having the smallest workload (e.g., which may be determined based on the number of channels 162 and/or logistical events 161 assigned to the task execution individual) may be assigned the channel 162 located at the top of the table included in the site section, vendor section, and/or job section. This can enable the channel having the most urgent logistical event(s) 161 to be assigned before other channels having less urgent logistical event(s) 161. Each time a channel 162 is assigned to a task execution individual, the channel allocation component 160 may reevaluate the workloads of each task execution individual, and then assign the next channel 162 located at the top of one of the tables to the task execution individual currently determined to have the smallest workload. The channel allocation component 160 can automatically assign the channels 162 to task execution individuals in other ways as well.

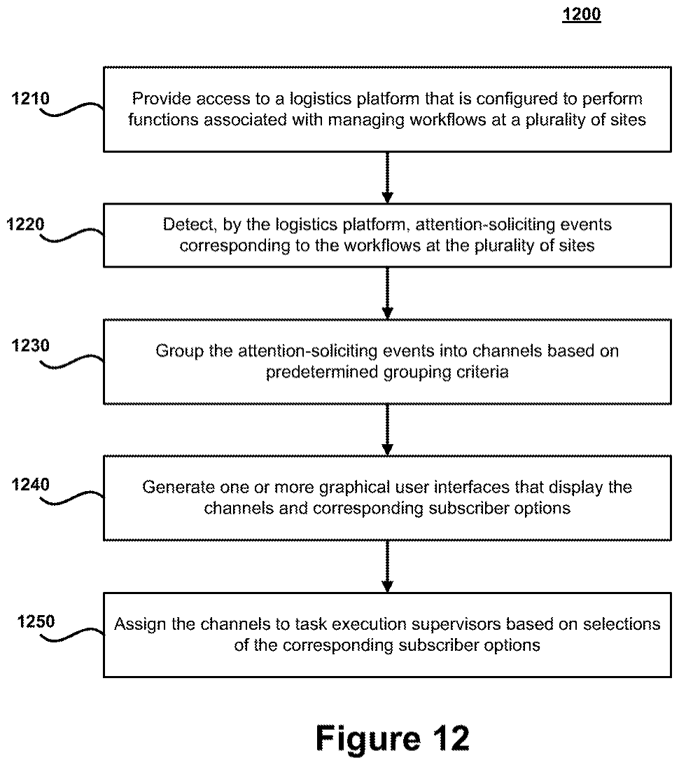

FIG. 12 is a flow chart for a method 1200 for generating channels 162 and assigning the channels 162 to task execution individuals according to certain embodiments. In certain embodiments, the method may be executed in whole or in part by the platform hosting device 130, the platform 150, and/or the channel allocation component 160.

In step 1210, access is provided to a logistics platform 150 that is configured to perform functions associated with managing workflows at a plurality of sites. Access to the logistics platform 150 may be provided to task execution individuals, vendors, property managers, and/or other stakeholders. These individuals may access the logistics platform 150 using computing devices 110. Access to the logistics platform 150 also may be provided to equipment (e.g., monitoring equipment 124, remediation equipment 126, IFM equipment, and/or other equipment) located at the sites 120 to enable communication between the equipment at the logistics platform 150.

In step 1220, logistical events 161 corresponding to the workflows at the plurality of sites 120 are detected by the logistics platform 150. The logistical events 161 may correspond to tasks, deadlines, and/or other issues associated with the sites 120 that solicit attention. For example, the logistical events 161 may relate to tasks associated with managing biological conditions (e.g., legionella conditions and/or other biological conditions), chemical conditions, and/or IFM conditions at the sites 120. The logistical events 161 may be detected by the logistics platform 150 in various ways. In certain embodiments, dynamic models 151 can be utilized to model the workflows at the sites 120, and logistical events can be detected or generated using the dynamic models 151. The logistical events 161 may also be detected based on monitoring information, inputs, and/or communications that are generated by equipment at the sites 120 and transmitted to the logistics platform 150 (e.g., in response to the equipment detecting that biological conditions, chemical conditions, and/or IFM conditions at the sites should be handled). The logistical events also may be detected or generated based on monitoring information, inputs, or communications received from the stakeholders utilizing the computing devices 110. For example, in certain embodiments, as vendors or other stakeholders perform tasks at the sites 120, these individuals may provide feedback to the logistics platform 150 utilizing the computing devices 110, and the feedback may trigger logistical events 161 and/or facilitate the generation or detection of logistical events 161. The logistical events 161 may be detected in other ways as well.

In step 1230, the logistical events 161 are grouped into channels 162 based on predetermined grouping criteria 163. As explained above, this may involve grouping the logistical events 161 into channels on a per site basis (such as the channels 162 included in the site section 710), per vendor basis (such as the channels 162 included in the vendor section 720), and/or per job basis (such as the channels 162 included in the job section 730). The logistical events 161 can additionally, or alternatively, be grouped according to other categories of grouping criteria 163 as well.

In step 1240, one or more graphical user interfaces (GUIs) are generated that display the channels 162 and corresponding subscriber options. As explained above, the channel allocation component 160 may be configured to generate and display the one or more GUIs that include the channels 162 and corresponding subscriber options (e.g., as illustrated in FIG. 7). The channel allocation component 160 also can be configured to determine an ordering of the channels 162 displayed on the one or more GUIs. In certain embodiments, the channel allocation component 160 orders and/or prioritizes channels 162 based on upcoming deadlines or expected due dates (e.g., such that the channels 162 having the most immediate deadlines appear first and are followed by channels 162 with less immediate deadlines). The channel allocation component 160 can determine the ordering of the channels 162 in other ways as well.

In step 1250, the channels 162 are assigned to task execution individuals based on selections of the corresponding subscriber options. In certain embodiments, the channels 162 can alternatively, or additionally, be assigned to the task execution individuals automatically by the channel allocation component 160. For each channel 162 that is assigned, the corresponding task execution individual that is subscribed to the channel 162 may be responsible for executing, managing, and/or overseeing completion of the logistical events associated with channel 162.

As logistical events 161 are completed, they may be marked as completed (e.g., automatically by the logistics platform 150 and/or by individuals selecting options on GUIs) and any data associated with the logistical events 161 may be stored or archived on the electronic platform 150 for subsequent retrieval and viewing. For example, the stored and/or archived data may indicate, inter alia, the site 120 associated with the logistical event 161, the vendor(s) and/or task execution individual(s) assigned to the event, the type of task associated with the logistical event 161, the date the logistical event 161 was detected, and/or the date the logistical event 161 was marked as complete. Other types of data associated with the logistical events may also be stored on the electronic platform 150.

Additionally, as logistical events 161 are completed, the interfaces (e.g., interface 700 in FIG. 7) generated by the logistics platform 150 may be automatically updated to reflect their completion. In some cases, the completion of a logistical event 161 may result in a channel 162 being removed from the interfaces. For example, completion of a logistical event 161 may result in a channel 162 being removed from the job section 730. Likewise, if there is only one pending logistical event 162 associated with a site or vendor, corresponding channels 162 included in the site section 710 and/or vendor section 720 may be removed from the interfaces.

In certain embodiments, completion of logistical events 161 may change the ordering of the channels 162 on the interfaces (e.g., may result in a reordering of the channels 162 included in the site section 710, vendor section 720, and/or job section 730). As mentioned above, the channels 162 may be displayed in tables or lists that order or prioritize the channels based on the urgency of deadlines. For example, in scenarios where the most urgent logistical event 161 associated with a particular site or vendor has been completed (but the site or vendor is still associated with other pending logistical events 161), a channel 162 associated with the site or vendor may be deprioritized to reflect the urgency of the next upcoming deadline associated with the site or vendor. This may result in the channel 162 appearing lower in the list or table.

Methods 400, 500, and 1200 are merely exemplary and are not limited to the embodiments presented herein. Methods 400, 500, and 1200 can be employed in many different embodiments or examples not specifically depicted or described herein. In some embodiments, the steps of methods 400, 500, and 1200 can be performed in the order presented. In other embodiments, the steps of methods 400, 500, and 1200 can be performed in any suitable order. In still other embodiments, one or more of the steps of methods 400, 500, and 1200 can be combined or skipped. In many embodiments, the logistics platform 150 can be suitable to perform methods 400, 500, and 1200 and/or one or more of the steps of methods 400, 500, and 1200. In these or other embodiments, one or more of the steps of methods 400, 500, and 1200 can be implemented as one or more computer instructions configured to run on one or more processing modules (e.g., CPUs, microcontrollers, control circuits, etc.) and configured to be stored at one or more non-transitory memory storage modules.

It should be noted that any feature described for an embodiment illustrated in the figures or otherwise disclosed herein can be incorporated into, or combined with, any other embodiment described herein. Moreover, one of ordinary skill in the art would recognize that the configurations, and/or implementations of the logistics platform can vary, and that the components of the platform can be configured in other arrangements.

In certain embodiments, a system for managing biological conditions at a plurality of sites. The system comprises: a plurality of cooling or water tower structures located at a plurality of sites; at least one computing device having at least one processor and at least one non-transitory storage device that stores instructions, wherein execution of the instructions by the at least one processor causes the at least one computing device to: provide access to an electronic logistics platform that is configured to perform functions associated with monitoring or remediating biological conditions at the plurality of sites, the biological conditions pertaining to legionella conditions at the plurality of cooling or water tower structures; detect logistical events, at least in part, using one or more dynamic models that define workflows at the plurality of sites, the logistical events corresponding to tasks to be executed in connection with monitoring or remediating the biological conditions at the plurality of sites; merge the logistical events into one or more channels based on grouping criteria; generate one or more graphical user interfaces that display the one or more channels; and assign the one or more channels to one or more individuals to facilitate execution of the tasks associated with logistical events.

In certain embodiments, a method is provided for managing biological conditions at a plurality of sites. The method comprises: providing, using one or more processors, access to an electronic logistics platform that is configured to perform functions associated with monitoring or remediating biological conditions at the plurality of sites, the biological conditions pertaining to legionella conditions at cooling or water tower structures located a plurality of sites; detecting, using the one or more processors, logistical events, at least in part, using one or more dynamic models that define workflows at the plurality of sites, the logistical events corresponding to tasks to be executed in connection with monitoring or remediating the biological conditions at the plurality of sites; merging, using the one or more processors, the logistical events into one or more channels based on grouping criteria; generating, using the one or more processors, one or more graphical user interfaces that display the one or more channels; and assigning, using the one or more processors, the one or more channels to one or more individuals to facilitate execution of the tasks associated with the logistical events.

In certain embodiments, a system is provided for managing biological conditions at one or more sites. The system comprises: at least one computing device having at least one processor and at least one non-transitory storage device that stores instructions, wherein execution of the instructions by the at least one processor causes the at least one computing device to: provide access to an electronic logistics platform that is configured to perform functions associated with monitoring or remediating biological conditions at the plurality of sites, the biological conditions pertaining to legionella conditions at one or more cooling or water tower structures located at a site; detect logistical events, at least in part, using one or more dynamic models that define one or more workflows for the site, the logistical events corresponding to tasks to be executed in connection with monitoring or remediating the biological conditions at the site; merge the logistical events into one or more channels based on grouping criteria; generate one or more graphical user interfaces that display the one or more channels; and assign the one or more channels to one or more individuals to facilitate execution of the tasks associated with the logistical events.

While there have been shown, described and pointed out various novel features of the invention as applied to particular embodiments thereof, it should be understood that various omissions, substitutions, and changes in the form and details of the systems and methods described may be made by those skilled in the art without departing from the spirit of the invention. Amongst other things, the steps in the methods may be carried out in different orders in cases where such may be appropriate. Those skilled in the art will recognize that the particular hardware and devices that are part of the system described herein, and the general functionality provided by and incorporated therein, may vary in different embodiments of the invention. Accordingly, the particular system components are provided for illustrative purposes and to facilitate a full and complete understanding and appreciation of the various aspects and functionality of particular embodiments of the invention as realized in the system and method embodiments thereof. Those skilled in the art will appreciate that the invention can be practiced in ways other than the described embodiments, which are presented for purposes of illustration and not limitation.

What is claimed is:

1. A system for managing biological conditions at a plurality of sites, the system comprising:
a plurality of cooling or water tower structures located at a plurality of sites;
at least one computing device having at least one processor and at least one non-transitory storage device that stores instructions, wherein execution of the instructions by the at least one processor causes the at least one computing device to:
provide access to an electronic logistics platform that is configured to perform functions associated with monitoring or remediating biological conditions at the plurality of sites, the biological conditions pertaining to legionella conditions at the plurality of cooling or water tower structures;
detect logistical events, at least in part, using one or more dynamic models that define workflows at the plurality of sites, the logistical events corresponding to tasks to be executed in connection with monitoring or remediating the biological conditions at the plurality of sites;
merge the logistical events into one or more channels based on grouping criteria;
generate one or more graphical user interfaces that display the one or more channels; and
assign the one or more channels to one or more individuals to facilitate execution of the tasks associated with logistical events.

2. The system of claim 1, wherein execution of the instructions by the at least one processor causes the at least one computing device to:
receive monitoring information, via the electronic logistics platform, from one or more of: sensory devices which provide real-time tracking of the biological conditions at the plurality of sites, and electronic computing devices that transmit the monitoring information over a network to track the biological conditions at the plurality of sites.

3. The system of claim 2, wherein the one or more dynamic models utilize the monitoring information to manage the workflows and detect the logistical events.

4. The system of claim 1, wherein:
the grouping criteria merge the logistical events at least into:
a plurality of site channels that consolidate the logistical events on a per site basis; and
a plurality of vendor channels that consolidate the logistical events on a per vendor basis; and
the one or more graphical user interfaces display the plurality of site channels and the plurality of vendor channels.

5. The system of claim 4, wherein:
the plurality of site channels include a separate channel corresponding to each of the plurality of sites, and each site channel can be selected to access a first graphical user interface that displays any pending logistical events associated with the corresponding site and any vendors that are assigned to manage performance of the pending logistical events associated with the corresponding site; and
the plurality of vendor channels include a separate channel corresponding to each vendor assigned to the plurality of sites, and each vendor channel can be selected to access a second graphical user interface that displays the pending logistical events associated with a corresponding vendor and any sites that are being serviced by the corresponding vendor.

6. The system of claim 4, wherein:
the first graphical user interface further identifies any individuals who are subscribed to channels pertaining to the pending logistical events associated with the corresponding site or the vendors assigned to manage performance of the pending logistical events associated with the corresponding site; and
the second graphical user interface indicates whether any individuals are subscribed to channels pertaining to the pending logistical events associated with the corresponding vendor and any sites that are being serviced by the corresponding vendor.

7. The system of claim 4, wherein:
the one or more graphical user interfaces displaying the plurality of site channels indicate earliest due dates that logistical events are to be completed at each of the sites;
the one or more graphical user interfaces displaying the plurality of vendor channels indicate earliest due dates that logistical events are due to be completed by each vendor; and
the plurality of site channels and the plurality of vendor channels are ordered based, at least in part, on the earliest due dates.

8. The system of claim 4, wherein the one or more graphical user interfaces displaying the plurality of site channels indicate for each site whether any logistical events have not been completed by an expected due date.

9. The system of claim 1, wherein the grouping criteria further merge the logistical events into job channels that consolidate the logistical events on a per job basis.

10. The system of claim 1, wherein the one or more channels are automatically assigned to the one or more individuals by the electronic logistics platform or the one or more channels are assigned to the one or more individuals in response to one or more subscriber options being selected.

11. A method for managing biological conditions at a plurality of sites, the method comprising:
providing, using one or more processors, access to an electronic logistics platform that is configured to perform functions associated with monitoring or remediating biological conditions at the plurality of sites, the biological conditions pertaining to legionella conditions at cooling or water tower structures located a plurality of sites;
detecting, using the one or more processors, logistical events, at least in part, using one or more dynamic models that define workflows at the plurality of sites, the logistical events corresponding to tasks to be executed in connection with monitoring or remediating the biological conditions at the plurality of sites;
merging, using the one or more processors, the logistical events into one or more channels based on grouping criteria;
generating, using the one or more processors, one or more graphical user interfaces that display the one or more channels; and
assigning, using the one or more processors, the one or more channels to one or more individuals to facilitate execution of the tasks associated with the logistical events.

12. The method of claim 11, the method further comprises:
receiving monitoring information, via the electronic logistics platform, from one or more of: sensory devices which provide real-time tracking of the biological conditions at the plurality of sites, and electronic computing devices that transmit the monitoring information over a network to track the biological conditions at the plurality sites.

13. The method of claim 12, wherein the one or more dynamic models utilize the monitoring information to manage the workflows and detect the logistical events.

14. The method of claim 11, wherein:
the grouping criteria merge the logistical events at least into:
a plurality of site channels that consolidate the logistical events on a per site basis; and
a plurality of vendor channels that consolidate the logistical events on a per vendor basis; and
the one or more graphical user interfaces display the plurality of site channels and the plurality of vendor channels.

15. The method of claim 14, wherein:
the plurality of site channels include a separate channel corresponding to each of the plurality of sites, and each site channel can be selected to access a first graphical user interface that displays any pending logistical events associated with the corresponding site and any vendors that are assigned to manage performance of the pending logistical events associated with the corresponding site; and
the plurality of vendor channels include a separate channel corresponding to each vendor assigned to the plurality of sites, and each vendor channel can be selected to access a second graphical user interface that displays the pending logistical events associated with a corresponding vendor and any sites that are being serviced by the corresponding vendor.

16. The method of claim 14, wherein:
the first graphical user interface further identifies any individuals who are subscribed to channels pertaining to the pending logistical events associated with the corresponding site or the vendors assigned to manage performance of the pending logistical events associated with the corresponding site; and
the second graphical user interface indicates whether any individuals are subscribed to channels pertaining to the pending logistical events associated with the corresponding vendor and any sites that are being serviced by the corresponding vendor.

17. The method of claim 14, wherein:
the one or more graphical user interfaces displaying the plurality of site channels indicate earliest due dates that logistical events are to be completed at each of the sites;
the one or more graphical user interfaces displaying the plurality of vendor channels indicate earliest due dates that logistical events are due to be completed by each vendor; and
the plurality of site channels and the plurality of vendor channels are ordered based, at least in part, on the earliest due dates.

18. The method of claim 14, wherein the one or more graphical user interfaces displaying the plurality of site channels indicate for each site whether any logistical events have not been completed by an expected due date.

19. The method of claim 11, wherein the one or more channels are automatically assigned to the one or more individuals by the electronic logistics platform or the one or more channels are assigned to the one or more individuals in response to one or more subscriber options being selected.

20. A system for managing biological conditions at one or more sites, the system comprising:
at least one computing device having at least one processor and at least one non-transitory storage device that stores instructions, wherein execution of the instructions by the at least one processor causes the at least one computing device to:
provide access to an electronic logistics platform that is configured to perform functions associated with monitoring or remediating biological conditions at the plurality of sites, the biological conditions pertaining to legionella conditions at one or more cooling or water tower structures located at a site;
detect logistical events, at least in part, using one or more dynamic models that define one or more workflows for the site, the logistical events corresponding to tasks to be executed in connection with monitoring or remediating the biological conditions at the site;
merge the logistical events into one or more channels based on grouping criteria;
generate one or more graphical user interfaces that display the one or more channels; and
assign the one or more channels to one or more individuals to facilitate execution of the tasks associated with the logistical events.
